(19) United States
(12) Patent Application Publication
(10) Pub. No.: US 2026/0027935 A1
(43) Pub. Date: Jan. 29, 2026

(54) METHOD FOR SIMULATING AND OPTIMIZING ELECTRIC VEHICLE CHARGING TO REDUCE CARBON FOOTPRINT

(71) Applicant: VOLKSWAGEN AKTIENGESELLSCHAFT, Wolfsburg (DE)

(72) Inventors: Ethan BOROSON, Alameda, CA (US); Mohak BHIMANI, Sunnyvale, CA (US)

(21) Appl. No.: 18/781,676

(22) Filed: Jul. 23, 2024

(51) Int. Cl. B60L 53/64; B60L 53/50; B60L 53/66; B60L 58/12

(52) U.S. Cl. CPC B60L 53/64; B60L 53/50; B60L 53/665; B60L 58/12; B60L 2240/80; B60L 2260/44; B60L 2260/46; B60L 2260/54; B60L 2270/10

(57) ABSTRACT

Total charging time to charge an EV from a starting SOC to a target SOC is determined based on vehicle related data. Home energy usage of a home in an EV availability time window is also determined based on home related data. EV idle power consumptions for an EV charging mode, an EV discharging mode, and an EV idle mode with neither charging nor discharging are further determined. A genetic algorithm is set up with cost and penalty functions. These functions are built, for each candidate schedule in a solution space, based on the starting state of charge, the home energy usage and the EV idle power consumptions. The genetic algorithm is run to generate an optimized schedule that includes schedule values for the time slots in the EV availability time window to control whether the EV is to charge, discharge or idle in each of these time slots.

### TECHNICAL FIELD

Embodiments relate generally to electric vehicles, and, more specifically, to simulating and optimizing electric vehicle charging to reduce carbon footprint.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Demands from electric vehicles (EVs) on electricity grids are growing rapidly as more and more EVs are being made by vehicle manufacturers and used by vehicle owners for daily driving needs. Various techniques including artificial intelligence (AI) or machine learning (ML) techniques have been developed to achieve better fuel economy or reduce fuel consumption through optimization of limited parameters used in vehicle related operations.

Electricity grids may provide electricity that is originally generated from a variety of energy source types such as coal, natural gas, wind, solar, hydro, etc. Hence, the grids may use or supply electricity generated from different mixes of fossil fuel, renewable and green energy sources at different time points to satisfy electricity demands some of which come from the EVs and/or homes. As a result, the electricity demands from the EVs and/or homes can very well be frequently met by electricity generated from fossil fuel and energy sources other than green energy sources.

### BRIEF DESCRIPTION OF DRAWINGS

The present disclosure is illustrated by way of example, and not by way of limitation, in the figures of the accompanying drawings and in which like reference numerals refer to similar elements and in which:

FIG. 1A illustrates an example framework 100 for optimizing carbon footprints;

FIG. 1B illustrates an example system for optimizing carbon footprints;

FIG. 2A illustrates an example simulation and optimization setup or process flow;

FIG. 2B illustrates example operational modes of energy exchange relating to an EV or a home;

FIG. 2C illustrates example operations to generate a full cost based at least in part on cost and penalty functions; FIG. 2D illustrates an example optimization problem to be solved for generating optimized schedule for charging an electric vehicle.

FIG. 3A illustrates an example visualization of time slots with respective schedule values; FIG. 3B illustrates an example visualization or display page of cumulative emissions generated under different EV charging techniques;

FIG. 4A and FIG. 4B illustrate example process flows; and

FIG. 5 is block diagram of a computer system upon which embodiments of the disclosure may be implemented.

### DETAILED DESCRIPTION OF THE INVENTION

In the following description, for the purposes of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure.

Embodiments are described herein according to the following outline:
1.0. General Overview
2.0. Structural Overview
   2.1. Electricity Grids
   2.2. Electricity Grid Data Collector
   2.3. Electric Vehicle Data Collector
   2.4. Home Data Collector
   2.5. Demand and Footprint Prediction Models
   2.6. Demand and Footprint Visualization
   2.7. Charging and Discharging schedule generator
3.0. Functional Overview
   3.1. Minimizing Costs
   3.2. System Operations
   3.3. Simulation and Optimization
   3.4. Schedule Values
   3.5. Schedule Evaluation
   3.6. Example Operations
   3.7. Example Visualization
4.0. Example Process Flows
5.0. Implementation Mechanism—Hardware Overview
6.0. Extensions and Alternatives

### 1.0 GENERAL OVERVIEW

Techniques as described herein can be used to improve overall carbon footprints of electricity or energy consumption by electric vehicles and/or homes (e.g., residence buildings, residence houses or apartments or flats, etc.). These techniques can be used to build optimization models and leverage prediction models for energy demand and associated charging behavior.

Generally speaking, any form of energy generation has an associated carbon footprint. As used herein, “footprint” or “carbon footprint” may refer to quantities, volumes, weights, etc., of greenhouse gas or carbon dioxide gas emissions as a result of electricity or energy supply or consumption. Example carbon footprints as described herein may, but are not necessarily limited to only, be associated or measured in relation to one or more of: specific electricity grid(s), specific geographic area(s)/location(s), specific vehicle manufacturer(s), specific vehicle model(s), specific home locations, specific combinations of home appliances used in homes, etc. In a non-limiting example, carbon footprints may refer to greenhouse gas or carbon dioxide gas emissions caused by generating electricity to meet electricity demands of a fleet of electric vehicles made by one or more specific vehicle manufacturers and/or homes with which the electric vehicles can be charged or discharged.

The techniques as described herein can be applied in a wide range of real-world operational scenarios to connect and operate with the systems used to operate the electricity grids with electricity consumers such as the electric vehicles and/or homes for carbon footprint reduction purposes. As a non-limiting example, some or all of these techniques can be implemented by a vehicle manufacturer (e.g., VW, Audi, Porsche, etc.) to influence demand, supply, and consumption of energy or electricity by a fleet of electric vehicles made by the vehicle manufacturer and/or by homes with which the electric vehicles can be discharged or charged. Hence, the carbon footprint relating to the fleet of electric vehicles (e.g., hybrid electric vehicles or HEV, battery electric vehicles or BEVs, etc.) and/or the homes can be significantly reduced or improved.

Several different energy sources may be combined to make up energy supply from electricity grid(s), resulting in an overall carbon intensity that varies over time. As used herein, “carbon intensity” may refer to physical quantities, volumes, weights, etc., of greenhouse gas emission per unit of electricity supply or consumption and/or per unit (e.g., 10 minutes, 15 minutes, 20 minutes, etc.) of time. As electricity supplies at different time points or intervals may be generated or supplied from different mixes or combinations of energy or electricity source types, carbon intensities—or greenhouse gas or carbon dioxide gas emissions per unit of electricity supply or consumption per unit of time—at these different time points or intervals can be quite different. Additionally, optionally or alternatively, “carbon intensity” may refer to (e.g., location specific, multi-location, etc.) physical quantities, volumes, weights, etc., of greenhouse gas emission per unit of electricity supply or consumption and/or per unit (e.g., 10 minutes, 15 minutes, 20 minutes, etc.) of time related to a particular geographic area or location such as Santa Clara County, the entire northern California region, a collection of geographic areas or locations such as California and Germany in which a fleet of electric vehicles made by a vehicle manufacturer whether underlying electric grids are connected to the same electric power transmission networks or not, general for use cases in larger geographic locations. Hence, carbon intensity as described herein may be measured or determined at various granularity or aggregation levels of geography from sections or parts of a single electric grid to multiple transnational electric grids.

An insufficiently charged plug-in hybrid electric vehicle is likely to consume fossil fuel in vehicle operations and hence emits or causes to emit greenhouse gas or carbon dioxide gas at a relatively high rate. While an electric vehicle with sufficient electric power emits no or little greenhouse gas or carbon dioxide gas by itself, the electric vehicle may nevertheless consume electricity originally generated from an energy source (or source type) that does cause emissions. Different fuel or energy sources may generate or incur emissions at different rates or intensities, so how clean the EV actually operates depends on the energy produced by the grid while the vehicle is charging. For example, most EV owners may choose to charge their vehicles at night times when they arrive home from work. This may be very unclean energy, especially in a grid like California's that relies so heavily on solar panels for daytime energy production.

The techniques as described herein can be used to implement or provide a tool for simulating or tracking usage and cost in connection with home and/or EV energy consumption and optimizing energy and/or power transfer based in whole or in part on the simulated or tracked usage and cost. These techniques support a relatively high degree of mutually beneficial or symbiotic coexistence of homes and EVs, taking advantage of energy storage and bi-direction energy transfer capabilities of the EVs and green (e.g., solar, etc.) energy generation capabilities of the homes.

Under these techniques, the home and/or EV energy consumption or usage and its associated cost can be relatively realistically and digitally simulated, reproduced, replicated and/or represented. In some operational scenarios, genetic algorithms may be used in generating an optimized energy and/or power transfer (or prioritization) schedule based at least in part on the realistic representation or simulation of the real world. The problem of generating the optimized schedule prioritization may be broken down, partitioned, or reduced to solving a search-based optimization problem, for example using genetic algorithms. Additionally, optionally or alternatively, in some operational scenarios, AI/ML models or techniques may be used in generating an optimized energy and/or power transfer (or prioritization) schedule based at least in part on the realistic representation or simulation of the real world. The problem of generating the optimized schedule prioritization may be solved by training AI/ML models in a training phase with training dataset(s) and applying these trained AI/ML models in an application/inference phase.

A cost function can be used in or implemented with an optimization method, algorithm or process flow for scheduling charging or discharging events of an electric vehicle at a home. The cost function can be specifically specified or built to enable the optimization method/algorithm to be tailored to specific operational and/or electricity consumption needs. The optimization method, algorithm or process flow can include or operate with prediction or forecasting model(s) to schedule bidirectional energy transfer events to satisfy EV and home energy consumption while minimizing the overall cost.

Approaches, techniques, and mechanisms are disclosed for improving carbon footprint of electric vehicles and/or homes. Total charging time to be used to charge an electric vehicle (EV) from a starting state of charge (SOC) to a target SOC is determined, based at least in part on vehicle related data. Home energy usage of a home in an EV availability time window during which the EV is electrically connected with electricity infrastructure of the home via a home charger is also determined based at least in part on home related data. EV idle power consumptions for an EV charging mode, an EV discharging mode, and an EV idle mode with neither charging nor discharging are further determined. A genetic algorithm is set up with cost and penalty functions. The cost and penalty functions are built, for each candidate schedule in a plurality of candidate schedules in a solution space to be evaluated by the genetic algorithm, based at least in part on the starting state of charge, the home energy usage and the EV idle power consumptions. The genetic algorithm is run to generate an optimized schedule among the plurality of candidate schedules in the solution space. The optimized schedule includes a plurality of schedule values for the plurality of time slots in the EV availability time window to control whether the EV is to charge, discharge or idle in each time slot in the plurality of time slots.

In other aspects, the disclosure encompasses computer apparatuses and computer-readable media configured to carry out the foregoing techniques.

### 2.0. STRUCTURAL OVERVIEW

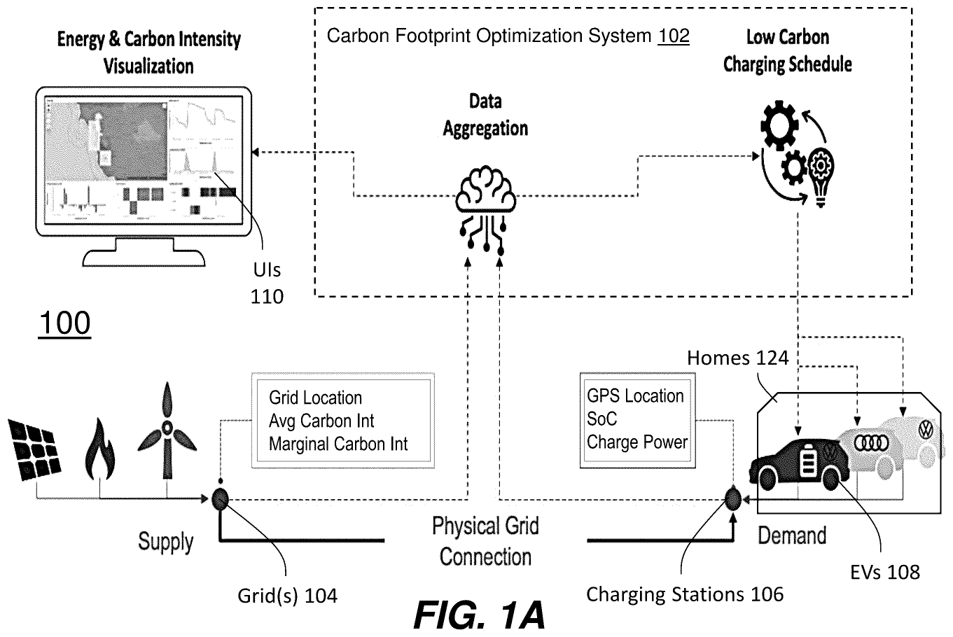

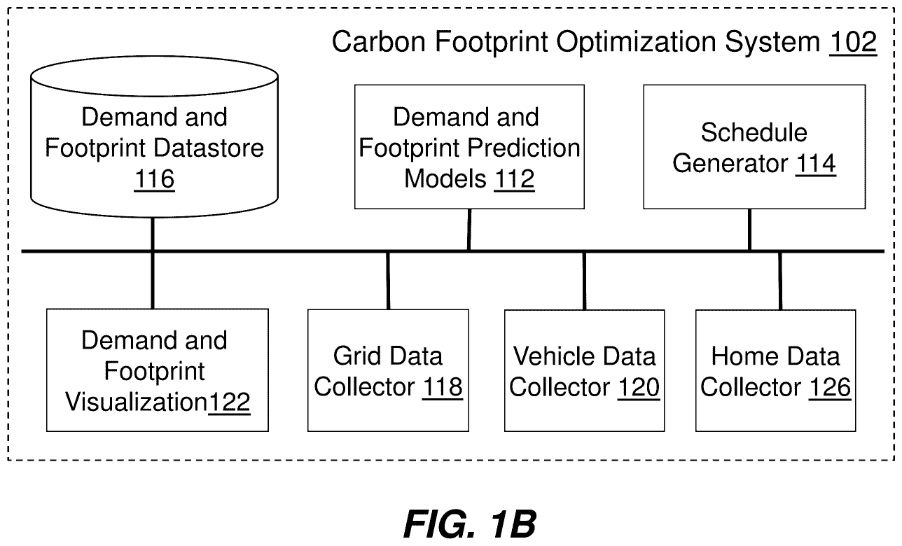

FIG. 1A illustrates an example framework 100 for optimizing carbon footprints relating to electric vehicles (EVs) and/or homes. The framework (100) comprises a carbon footprint optimization system 102, one or more grid(s) 104, (e.g., home-based, etc.) charging stations 106 at individual homes 124, individual EVs 108, UIs 110 for energy and carbon intensity visualization, etc. Also as illustrated in FIG. 1B, in some operational scenarios, the carbon footprint optimization system (102) further comprises demand and emission prediction models 112, an electric vehicle charging and energy/power transfer schedule generator 114, an electricity demand and carbon footprint datastore 116, an electricity grid data collector 118, an electric vehicle data collector 120, an electricity demand and carbon footprint visualization block 122, etc. The system (102) or subsystem(s) therein may be implemented with some or all of: artificial intelligence or AI techniques, machine learning or ML techniques, non-AI non-ML techniques, a combination of different types of computing techniques, etc. Each block, module, device, system, etc., illustrated in the framework (100) and/or the system (102) may be collectively or individually implemented with one or more computing devices that comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

### 2.1. Electricity Grids

Electricity grids are to comply with needs for electricity and meet/satisfy demands (e.g., within respective specified service territories, etc.) at respective geographic areas or locations in which the grids are deployed. Example geographic areas or locations may include, but are not necessarily limited to only, grid service areas/districts, villages, towns, cities, counties, states or portions therein, regions, nations, any combinations of the foregoing, etc.

A plurality of green, renewable, non-renewable and/or fossil fuel energy sources (or source types) such as coal, natural gas, wind, solar, hydro, etc., can be utilized by the grids to generate or supply electricity. As used herein, “green energy source” or “green energy source types” refer to energy sources or types whose generation/production causes no or little greenhouse gas or carbon dioxide gas emissions. “Renewable energy source” or “renewable energy source types” refer to energy sources or types that are naturally replenishable, for example over a reasonable time span such as yearly, every few years, etc. Examples of green and renewable energy sources or types are solar or wind. In comparison, “non-renewable energy source” or “non-renewable energy source types” refer to energy sources or types that are not naturally replenishable over a reasonable time span. Examples of non-renewable energy sources or types are various fossil fuels.

Due to the dynamic or time varying nature of electricity demands and supplies and intermittent nature of renewable energy sources, it may not always be possible to meet demands with electricity supplies generated with energy from 100% green and/or renewable energy sources. Sometimes, the grids are able to produce more electricity than needed to meet demands using only green and/or renewable resources. The excess energy can be exported to a neighboring grid or can be curtailed. Sometimes, fossil-fuel-based power plants—e.g., peak shaving plants (referred to as Peaker Plants)—are brought online to help meet marginal or average demands when the demands or corresponding loads increase and/or when electricity supplies generated from green and/or renewable sources diminish.

Under other approaches that do not implement techniques as described herein, from the energy or electricity supply side, electricity grids generally do not have a direct influence on energy demand. From the vehicle side, cars with bidirectional energy transfer capability have not been widely developed. Even though there are some cars in production today with bidirectional energy transfer capabilities, these cars have mostly been advertised and used as supplemental power during emergency electricity outage situations; bidirectional energy transfer events are triggered manually or follow a static schedule based on the energy rate (utility charged fee) structure without regard for underlying carbon emission costs. Hence, as the grid side and the demand side operate largely independently of each other, there is currently a lost or under-utilized opportunity to optimize energy usage and minimize greenhouse gas emissions.

In contrast, under techniques as described herein, electricity supplies from the grid(s) (104) and electricity demands from the electric vehicles (108) and/or the homes (124) can be shaped, influenced, mixed, combined and/or controlled by the system (102) to work hand in hand to help reach or accomplish a 100% renewable energy portfolio for electricity consumption by the electric vehicles (108) and/or the homes (124).

Users (e.g., vehicle owners or operators, home residents or owners, etc.) may opt in to using their personal electric vehicles for bidirectional energy/power transfer events and/or using home based energy and/or power generation and storage capabilities. The system (102) can make or implement suggestions of, or schedule, vehicle charging events and bidirectional energy/power transfer events at temporally constant or variable rates to help realize relatively large cost and emission reduction benefits possible for these users.

The system (102) can implement prediction models to simulate, track, predict, and influence electricity demands from the electric vehicles (108) and/or the homes (124) as well as energy supplies provided by the grid(s) (104) and/or home based electricity generation and/or electricity storage. These prediction models can operate with optimization models/algorithms—e.g., implemented in the system (102) or one or more subsystems therein—that generate or recommend optimized electricity charging and/or transfer events. Hence, the prediction models and/or relatively realistic simulations implemented in the system (102) can be leveraged with the optimization models/algorithms to generate optimized electricity charging and/or transfer events for the purpose of reducing electricity costs and/or emissions as intended or indicated by the users.

Localized energy demands—including but not limited to individual electricity demands of specific homes (124)—and associated greenhouse gas emissions in various geographic areas or locations in which the grid(s) (104) are deployed or physically connected with the electricity charging stations (106) to supply or draw electricity to or from the electric vehicles (108) can be simulated, tracked, predicted, or influenced by triggering or scheduling electric charging and/or discharging events at optimal or optimized times for the electric vehicles (108) and/or the homes (124). Example system(s) relating to electricity or energy demand and consumption are described in U.S. patent application Ser. No. 17/874,753, filed on Jul. 27, 2022, the contents of which are incorporated by reference herein.

### 2.2 Electricity Grid Data Collector

As shown in FIG. 1B, the system (102) may comprise an electricity grid data collector (118) that interacts with (grid) system(s) used to operate or control the electricity grid(s) (104) for the purpose of collecting grid data relating to the electricity grid(s) (104). The system (102) can be operationally or communicatively linked with the grid system(s) via one or more first data communication network connections over one or more first computer networks. The first data communication network connections can be supported or implemented with any combination of a wide variety of communication techniques including but not limited to those related to cellular communications, wire-based communications, wireless communications, optical communications, ethernet communications, etc.

Example grid data as described herein may include, but are not necessarily limited to only, some or all of: grid location(s), average carbon intensities, marginal carbon intensities, etc., of the electricity grid(s) (104). Additionally, optionally or alternatively, the grid data may include other grid data types such as source types of energy supply and production at each of some or all of the grid(s) (104), available transmission capacity used to satisfy electricity demands at each of some or all of the grid(s) (104), dynamic or estimated energy demands from consumers including but not limited to those related to the electric vehicles (108) at each of some or all of the grid(s) (104), available energy storage for electricity flowing to or from the grid(s) (104) at each of some or all of the grid(s) (104), etc. In some operational scenarios, additional grid data may be derived or computed from the collected grid data, for example by the system (102) or by an attendant system/device such as an aggregation node operating in conjunction with the system (102).

The collected grid data from the electricity grid(s) (104) (and/or the additional grid data if any) may be provided by the grid data collector (118) to other blocks or modules in the system (200). Additionally, optionally or alternatively, the grid data can be stored in, and managed or accessed through, the electricity demand and carbon footprint datastore (116).

### 2.3. Electric Vehicle Data Collector

As shown in FIG. 1B, the system (102) may comprise an electric vehicle data collector 120 that interacts with system(s) (not shown) used to operate the electric vehicle charging stations (106) and/or the electric vehicles (108) for the purpose of collecting vehicle data relating to the electric vehicles (108). The system (102) can be operationally or communicatively linked with the electric vehicle charging stations (106) and/or the electric vehicles (108) (or vehicle batter managements systems therein) via one or more second data communication network connections over one or more second computer networks. The second data communication network connections can be supported or implemented with any combination of a wide variety of communication techniques including but not limited to those related to cellular communications, wire-based communications, wireless communications, optical communications, ethernet communications, etc.

Example vehicle data may include, but are not necessarily limited to only, some or all of: geographic positioning system (GPS) generated locations, outputs from battery management systems deployed in or with electric vehicles, charging and/or bidirectional energy/power transfer capabilities of the electric vehicles, individual and/or overall states of charge (SoCs) of batteries and/or battery modules/packs in the electric vehicles, individual and/or overall (e.g., latent, history-dependent, age-dependent, use-dependent, dynamic, adjusted to aging, etc.) states of health (SoHs) of the batteries and/or battery modules/packs, current and/or past operational temperatures of the batteries and/or battery modules/packs, current and/or past operational voltages provided by the batteries and/or battery modules/packs, (e.g., percentage charged, full, etc.) charge powers of the batteries and/or battery modules/packs, user input from interacting with drivers or owners of the electric vehicles (108, etc., of the electric vehicles (108), and so on. In some operational scenarios, operational temperatures of the batteries of the electric vehicle as measured or outputted by a battery management system (e.g., in the electric vehicle, etc.) may be used as a part of (input) keys or index values or battery states to look up or determine specific penalty values from a penalty plot/function/curve. The penalty plot/function/curve may be represented as a multi-dimensional (look-up) table, which may be developed or specified before battery operations described herein, or dynamically updatable while the batteries are deployed in the field.

The collected vehicle data in connection with the electric vehicles (108) may be provided by the vehicle data collector (120) to other blocks or modules in the system (200). Additionally, optionally or alternatively, the vehicle data can be stored in or accessed through the electricity demand and carbon footprint datastore (116).

In addition to using the collected vehicle data to effectuate electricity charging of electric vehicles when the grids are using clean or green energy sources with no or little green house or carbon emissions, the system (102) can use the collected vehicle data to identify specific electric vehicles with bidirectional energy/power transfer capabilities and treat these electric vehicles as a source of energy to effectuate supplying electricity to homes with charging stations (or chargers) to which these electric vehicles are connected for charging or for vehicle-to-home energy transfer when the grids are using non-clean or non-green energy sources with relatively large green house or carbon emissions. In some operational scenarios, the electric vehicle charging stations (106) can be used to facilitate or support bi-directional energy/power transfer operations including transfer operations of electric energy/power from some or all of the electric vehicles (108) to the homes (124) or electricity wiring infrastructure therein to power or supply electricity to appliances or devices in or around the homes (124).

### 2.4. Home Data Collector

As shown in FIG. 1B, the system (102) may comprise a home (electricity) consumption and infrastructure data collector 126 that interacts with system(s) (not shown) and/or user(s)—such as resident(s)/owner(s) of the home or driver(s) owner(s)/operator(s) of EVs associated with the home—to obtain home electricity infrastructure data (e.g., maximum concurrent electricity load of the home, maximum electric current supported by the electricity network or wirings of the home, etc.), home based solar energy or power generation capability, home based energy storage capability. The home consumption and infrastructure data collector (126) may also interact with the system(s) to monitor electricity consumption of the homes (124). The system (102) can be operationally or communicatively linked with the homes (124) via one or more third data communication network connections over one or more third computer networks. The third data communication network connections can be supported or implemented with any combination of a wide variety of communication techniques including but not limited to those related to cellular communications, wire-based communications, wireless communications, optical communications, ethernet communications, etc. Additionally, optionally or alternatively, the system (102) may include or implement one or more user interfaces to interact with the users to generate user input relating to home electricity consumption and infrastructure.

Example home electricity consumption and infrastructure data may include, but are not necessarily limited to only, some or all of: geographic positioning system (GPS) generated locations, outputs from electricity consumption monitoring systems deployed in the homes (124), bidirectional energy/power transfer capabilities of the homes (124), solar generation capabilities and statuses, energy storage capabilities and statuses, etc. In some operational scenarios, the homes (124) or electricity wiring infrastructure therein can operate with, or receive vehicle transferred electricity and/or power by way of, the electric vehicle charging stations (106) to facilitate or support bi-directional energy/power transfer operations including transfer operations of electric energy/power from some or all of the electric vehicles (108) to power or supply electricity to appliances or devices in or around the homes (124).

The collected home electricity consumption and infrastructure data in connection with the homes (124) may be provided by the home data collector (126) to other blocks or modules in the system (200). Additionally, optionally or alternatively, the home electricity consumption and infrastructure data can be stored in or accessed through the electricity demand and carbon footprint datastore (116).

### 2.5. Demand and Footprint Prediction Models

As shown in FIG. 1B, the system (102) may comprise one or more demand and emission prediction models (112) to use the grid data, vehicle data and home (electricity consumption) data as raw data or input for predicting demands and emissions.

To achieve minimized carbon footprints or emissions associated with electric vehicles and/or homes, the prediction/forecast models (112) can be trained and used to make predictions for both emissions per unit amount of energy produced at any given time and the total energy demand at the time. The prediction/forecast models (112) can further be trained and used to make predictions in a given time period (e.g., from a specific time point such as a current wall clock time, etc.) such as up to one (1) day or one (1) week for energy consumptions and associated costs for home, grid and solar. Greenhouse gas or carbon gas emission data and electric energy demands (or patterns thereof) relating to electric vehicles and/or homes can be used to train or build the prediction/forecast models (112) in a model training phase. Operational parameters in the prediction/forecast models (112) such as weights or biases used with neuron activation functions of neural nets can be optimized by minimizing prediction/forecast errors of the prediction/forecast models (112). These prediction/forecast errors can be measured or determined in relation to labels or ground truths in training data base at least in part on objective functions, error functions, distance functions, penalty functions, etc., and back propagated to update the weights or biases of the neural nets for the purpose of generating relatively accurate predictions or estimations.

In a model application or deployment phase, the prediction/forecast models (112) with the optimized operational parameters can extract input features of the same types used in the model training phase and use the input features as input (e.g., input neurons, etc.) to generate predictions/forecasts of electricity demands and emissions at grid and/or vehicle levels and/or home levels.

### 2.6. Demand and Footprint Visualization

The system (102) comprises a demand and footprint visualization block (122 of FIG. 1B) visually present or display raw and/or processed demand and emission data including but not limited to report and trend data on the UIs (110) to electricity grid operators and/or human drivers or owners of the electric vehicles, for the purpose of planning, forecasting and/or optimizing electricity generation or supply of the electric grids and usages and operations of the electric vehicles. As used herein, “drivers” or “owners” of the electric vehicles may refer to (e.g., human, business entity, non-business entity, etc.) users or customers who own, operate or use the electric vehicles, and who subscribe to electricity/utility services provided by operators of the electricity grid(s) to meet demands of the electric vehicles for electricity. “Users” or “consumers” may also refer to residents, occupants, renters or owner of the homes at which the electric vehicles are connected to chargers or charging stations for electricity charging with energy supplied by the grids and/or for bidirectional energy/power transfers to the homes.

In an example, the grid data can be used as a part of the input to derive or generate electricity demand and/or carbon footprint display pages to be used in, or rendered on the UIs (110), by the electricity demand and carbon footprint visualization block (122). In another example, the vehicle data can be used as a part of the input to derive or generate electricity demand and/or carbon footprint display pages to be used in, or rendered on the UIs (110), by the electricity demand and carbon footprint visualization block (122). In another example, the home data can be used as a part of the input to derive or generate electricity demand and/or carbon footprint display pages to be used in, or rendered on the UIs (110), by the electricity demand and carbon footprint visualization block (122).

### 2.7. Charging and Discharging Schedule Generator

As shown in FIG. 1B, the system (102) may comprise a charging and discharging schedule generator (114) to perform relatively accurate and realistic simulations based on various factors including but not limited to collected information about any, some or all of: an EV such as any bidirectional capability, respective energy and/or power consumption at various operational states (e.g., charging state, idle state, discharging state, etc.), etc.; a home such as specific energy or power consumption by home appliances, maximum concurrent electricity or power loads supported by specific home (electric) infrastructure of the home, specific home based solar energy or power generation capability and status, specific home based energy storage capability and status, etc.; and so on.

To generate a simulation, information from both supply (e.g., grid data, carbon intensity information/data, home solar generation information/data, home energy storage information/data, etc.) and demand (e.g., vehicle idle power consumption, demand for future EV and home energy use, etc.) sides are integrated into the simulation. The simulation may be performed with each evaluated schedule (e.g., as generated by a genetic algorithm, by an AI/ML model or artificial neural networks, etc.) among some or all possible schedules in a solution space as a part of generating or optimizing a final or recommended charging (and/or discharging) schedule to minimize an overall cost that includes carbon footprint or emission associated with the production of energy and/or power used with the generated/optimized schedule.

In addition to implementing relatively advanced (or deeply realistic) simulation, the system (102) can implement optimization techniques to generate an optimal schedule for EV charging and/or discharging while the EV is available at the home.

In some operational scenarios, the system (102) may use or operate with a genetic algorithm provided by an available tool provider (e.g., commercial tool provider, etc.) such as MATLAB or another tool provider. The genetic algorithm may be used to generate or search for the optimized schedule within a relatively large solution space populated with relatively numerous (e.g., thousands, tens of thousands, hundreds of thousands, some or all, etc.) possible charging and/or discharging schedule choices/selections. Additionally, optionally or alternatively, in addition to or in place of genetic algorithm(s), relatively advanced AI/ML techniques/models may be used or trained to generate the optimized schedule.

These AI/ML and/or non-AI/ML techniques may be used as a part of the (e.g., bidirectional, EV charging or discharging, vehicle to home or V2H discharging, etc.) algorithms, methods or process flows to implement, perform or carry out bidirectional energy and/or power transfers (between or among the grid, home and EV) that effectively lower costs and carbon emissions without compromising EV battery health, thereby leading to relatively low (or minimized) overall emissions and cost for homes and/or EVs in the real world.

In some operational scenarios, the system (102) may be a non-distributed system implemented with one or more (e.g., cloud based, remote to or outside of electric vehicles, etc.) computing devices in a single location. Additionally, optionally or alternatively, in some operational scenarios, the system (102) may be a distributed system implemented with multiple (e.g., cloud based, remote or outside of electric vehicles, in electric vehicles, etc.) computing devices spanning or distributed across multiple locations. These computing devices may be connected with wireless network or data connections, wired network or data connections, a combination of wired or wireless connections, etc. Hence, the system (102) can operate in a variety of different system configurations or architectures or frameworks.

Methods, algorithms or process flows implemented in the system (102) can run centrally or distributed. Some methods, algorithms or process flows may be performed with in-vehicle devices/modules of the system (102).

In an example, multiple instances of the schedule generators may be respectively deployed in vehicle with the electric vehicles (108). Each instance in the multiple instances of the schedule generators may be used to simulate EV and/or home energy/power uses and/or to schedule or optimize charging events for a corresponding electric vehicle in which the instance is deployed.

In another example, multiple in-vehicle or in-charging-station schedule client-side optimizers or agents may be respectively deployed in vehicle with the electric vehicles (108). Each client-side optimizer or agent may operate with the (remote located or cloud-based) schedule generator (114) to simulate EV and/or home energy/power uses and/or schedule or optimize charging events for a corresponding electric vehicle in which the client-side optimizer or agent is deployed.

### 3.0. FUNCTIONAL OVERVIEW

In an embodiment, some or all techniques and/or methods described below may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### 3.1. Minimizing Costs

Other approaches and/or options and/or methodologies for end users to schedule vehicle charging are available but not always widely used. A principal limitation of these other approaches, options or methodologies is a lack of ability to define the problem statement with the highest degree of fidelity and represent the optimization problem in a realistic and accurate manner to eventually maximize or minimize a quantity associated with the outcome.

Given this principal limitation, these other approaches, options or methodologies may not automatically and optimally schedule vehicle charging to times when emissions or costs associated with these charges are at the lowest, but rather may need to rely heavily on user input to indicate or determine correct or optimized times to charge an EV. However, added complexities of various factors (e.g. vehicle idle power consumption, home solar generation data, home energy storage, specific limited capabilities of home electric infrastructure, etc.) could very well result in a situation in which a human (e.g., EV user, EV owner, etc.) may be severely challenged to provide user input used to optimize charging and discharging operations of an EV. Thus, user input itself may not be accurate or realistic in many operational scenarios.

In comparison, the system (102) as described herein can help address the principal limitation inflicting these other optimization approaches, options or methodologies. The system (102) is enabled to simulate or represent real world energy and/or power consumption and/or EV and home behaviors in connection with homes and EVs with a relatively high degree of fidelity, realism and accuracy.

In reality, charging or bidirectional discharging performed by or with an EV can incur (e.g., inherent, basic, minimum, etc.) energy or power consumption to keep relevant in-vehicle systems or subsystems running. Realistic simulations performed by the system (102) can take into account energy or power consumption of the EV in various running or operational states (e.g., idle state, charging state, discharging state, etc.) to generate a relatively accurate prediction or estimation of overall energy and/or power consumption in connection with homes and EVs.

The realistically simulated vehicle behaviors or energy/power consumptions in charging and discharging scenarios may be used by the system (102) to allow or perform (e.g., fully automated, with no or little user input, etc.) computer-aided optimization to determine the ideal schedule—or the one incurring the least cost from among some or all possible schedules that constitute a solution space—for EV charging and/or discharging at a relatively high speed or with a relatively low time latency/delay.

The automatic optimization of charging and discharging operations with the system (102) can take into account fully of specific factors associated with specific home infrastructure, specific home energy generation and storage capabilities, specific EV operational characteristics, specific EV charging and/or discharging capabilities with no or little user input. Hence a user can make use of or approve the ideal or most optimized schedule with no or little difficulty.

In some operational scenarios, an optimization problem can be solved by the system (102), and the solution to the optimization problem can be used as an optimized schedule for EV charging and/or discharging. Under techniques as described herein, this optimization problem can be defined or specified with a relatively high accuracy and confidence level to eventually maximize or minimize a (physical) quantity associated with the outcome of the system.

The system (102) can automatically solve the optimization problem—e.g., using genetic algorithms and/or AI/ML based techniques/models, through or after evaluating some or all possible schedules constituting a solution space, etc.—and generate the optimized schedule with variable charging (and/or discharging) rates as the solution to the optimization problem. The optimized solution—as automatically generated by the system (102) with no or little user input based on relatively accurate cost and/or emissions predicted or generated—can still be further reviewed, revised, approved or adopted by end users.

Some (e.g., relatively old, etc.) homes may have infrastructure unable to support charging an EV at full power while using other (home based) appliances simultaneously. As home chargers—or home based EV charging stations—become more and more powerful, this problem can exacerbate as the home infrastructure without adequate update may not keep up with the increasingly larger energy and/or power demands from home electric vehicle supply equipment (EVSE) or home chargers. The system (102) can help meet these challenges, perform relatively realistic simulations of EV and home energy and/or power consumption in various charging and/or discharging scenarios, and support variable charging rates at relatively fine time granularity in accordance with specific home infrastructure capabilities of these homes—for example, charging, idle or discharging rates or operational states in an optimized schedule as described herein may be set differently for different minutes.

Some homes may be equipped with solar panels and/or external batteries. These specific home infrastructure capabilities can be accounted for in realistic simulations performed by the system (102) and used or exploited by the system (102) to change mixes or combinations of home and/or EV consumed energy and/or power. For example, energy and/or power generated by home based solar panels or stored in home based external batteries may be used by the system (102) to charge EV batteries. In other words, home based solar generation and/or storage may be used as a part of data input for the system (102) to perform simulations and determine variable charging rates at which an EV may be charged at the home.

Bidirectional charging capabilities may not be widely available in EVs operating in some geographic regions or countries and, even if available, have not truly been utilized or optimized fully. The system (102) can fully take into account bidirectional (V2H) discharging to lower emissions beyond what could be achieved by other approaches such as only moving charging events. For example, the system (102) can use any available bidirectional charging capabilities to further reduce or minimize emissions generated with the production of the electricity used to power both some or all of these EVs and homes.

In some operational scenarios, the system (102) can be implemented with an original manufacturer of a relatively large population or fleet of EVs to take advantage of a relatively large volume of accurate vehicle data. The overall home and vehicle electricity ecosystem can be considered or evaluated in a relatively realistic representation to minimize overall carbon footprints of the EVs and homes at which these EVs are charged or discharged.

Information about how vehicles in the population operate—such as including any energy and/or power draw or usage of an EV idling—can be collected, configured in, or incorporated by the system (102) into relatively accurate simulations that are much more realistic with respect to how a real vehicle would behave than other systems implemented by parties/vendors lacking accurate (e.g., proprietary, etc.) vehicle operational data as compared with the manufacturer. With the accurate simulations, end users or operators/drivers of the EVs in the population of vehicles of the same original manufacturer can be provided with a relatively easy-to-use but also fully customizable system or subsystem that will allow these users to take full advantage of batteries of their EVs to reduce carbon emissions and/or reduce.

As a result, the system (102) can provide a relatively trusted and simple solution for EVs or vehicle electrification in general. This solution can adaptively and optimally cover specific customer-oriented or end user needs such as automatically selecting ideal or optimized times/schedules in various vehicle home availability time windows to charge (and/or discharge) EVs at a home for cost saving purposes without sacrificing EV ranges. The solution—e.g., through visualization display pages or user interfaces, etc.—can also help increase or enhance end user awareness towards reducing or minimizing carbon footprints.

### 3.2. System Operations

The system (102) collects grid data relating to the electric grid(s) (104). The collected grid data may include, but are not necessarily limited to only, data regarding multiple underlying systems involved in generating, producing, storing and distributing energy or electricity to the electric vehicles (104) or consumer devices other than (plug-in) electric vehicles or hybrid electric vehicles. In addition, the system (102) collects vehicle-related data from the electric vehicles (108) and/or the (e.g., in-home, in-office, commercial, etc.) charging stations as well as collects home-related data collected from electricity consumption monitoring systems in the homes (124).

The prediction (or forecast) models (112) built in with the system (102) can operate to use the raw data collected from systems used to operate the grid(s) (104), the charging stations (106), the electric vehicles (108), and/or the homes (124) to generate estimations of demands for electricity and emissions of these demands as well as other demands (not for the electric vehicles (108)) for electricity. These predictions or estimations of electricity demands and emissions from prediction/forecast models (112) in the system (102) may include, but are not necessarily limited to only, some or all of: current day demands of the electric vehicles (108), upcoming week's forecast demands of the electric vehicles (108), past, present and future emissions associated with charging the electric vehicles (108), current day demands of the homes (124), upcoming week's forecast demands of the homes (124), past, present and future emissions associated with electricity consumption of the homes (124), etc. The system (102) can use these estimations to plan or schedule relatively smart/green charging and/or bidirectional energy/power transfer events for the electric vehicles (108) and/or the homes (124) and influence charging and transfer patterns in connection with electricity demands or consumptions of the electric vehicles (108) and/or the homes (124).

For example, in some operational scenarios, the system (102) can be used to enable a relatively large vehicle manufacturer (e.g., VW, Audi, Porsche, etc.) to respond to, influence and reshape dynamic or time varying demands for electricity from a relatively large population of electric or electrified vehicles made by the manufacturer and/or from homes hosting these vehicles to result in an added demand flexibility for minimizing emissions and for enhancing or increasing economic or monetary incentive associated with the reduction of the (e.g., CO2, etc.) emissions. Hence, the techniques as described herein can be used to enable the vehicle manufacturer to reduce or minimize overall emissions and expenses associated with vehicles produced by the manufacturer. More specifically, the demand flexibility enabled with the system (102) can be exploited to minimize greenhouse gas emission or carbon footprint associated with operations of the electric vehicles and electricity consumption of the homes, for example through optimizing charging and/or energy/power transfer schedules in connection with the electric vehicles and/or the homes (124).

The vehicle charging and energy/power transfer schedule generator (114) in the system (102) may implement a process flow or algorithm for generating optimized charging, recharging and/or bidirectional energy/power transfer events or schedules for an electric vehicle and/or a home at which the electric vehicle is connected to a charging station. In some operational scenarios, the process flow or algorithm may be in part or in whole performed by an instance or portion of the schedule generator (114) of the system (102) implemented by one or more computing devices in an electric vehicle. Some or all of the process flow or algorithm can be performed in vehicle to set up a specific charging, recharging or bidirectional energy/power transfer event with a selection of a specific optimized time or interval to charge, recharge, or effectuate a bidirectional energy/power transfer to home from, the electric vehicle. The process flow or algorithm can access the demand and footprint prediction models (112) to determine, or generate an estimation of, expected or forecasted demand of the electric vehicle and/or the home for electricity, energy or power until the next charging session or event for the electric vehicle. The process flow or algorithm can also determine the time that the electric vehicle needs to be ready to leave by, for example based at least in part on user input received from the driver or owner of the vehicle; simulate specific home and/or EV energy and/or power consumption for each schedule option/selection; and generate an optimized schedule (e.g., the best among all possible schedules constituting a solution space, etc.) for charging, discharging, or effectuate a bidirectional energy/power transfer at variable charging (and/or discharging) rates at a relatively fine time granularity (e.g., every minute, etc.) to or from home and the electric vehicle before that time.

Most drivers charge their electric vehicles when they return home from work or schedule an overnight charge when electricity is not subject to peak pricing. While the electricity may be cheaper, producing the electricity during these hours may generate significant greenhouse gas or carbon gas emissions, for example in a grid that relies heavily on solar power such as in California.

Instead of charging electric vehicles that may well inadvertently induce relatively high emission costs, the system (102) as described herein can be used to provide a user or owner of an electric vehicle and/or a home at which the electric vehicle is charged with a better option to minimize carbon impacts of owning and driving the electric vehicle and/or consuming electricity at the home. For example, the system (102) can cause the electric vehicle to be charged and/or recharged for bidirectional energy/power transfer during specific daytime hours (if possible) when utility cost for electricity is still cheap, but as the sun is up, the electricity can be generated using solar energy that prevents or reduces greenhouse gas or carbon gas emissions across the grid used to charge and/or recharge the electric vehicle for vehicle operations and/or home electricity consumption.

This saving of emissions can be multiplied across some or all of the electric vehicles (108) and/or the homes (124), which can lead to a significant reduction in greenhouse gas or carbon gas emissions generated by charging numerous electric vehicles and/or consuming electricity by numerous homes worldwide.

### 3.3. Simulation and Optimization

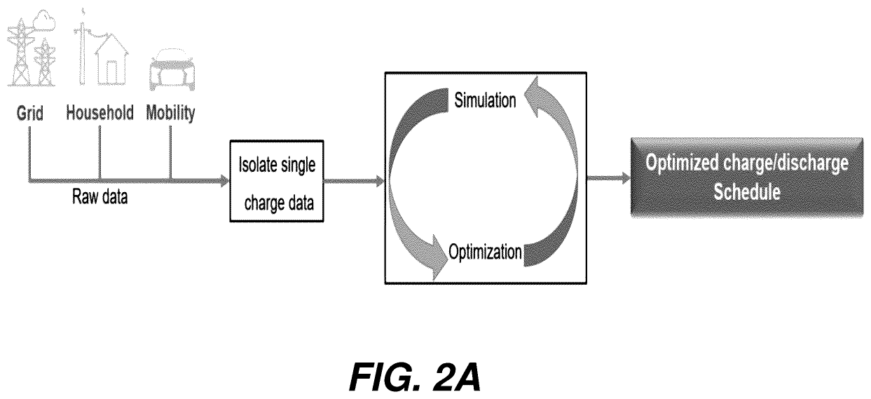

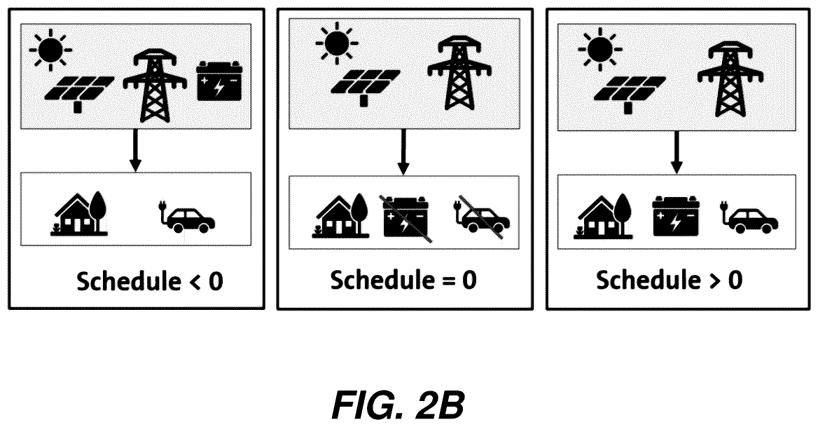

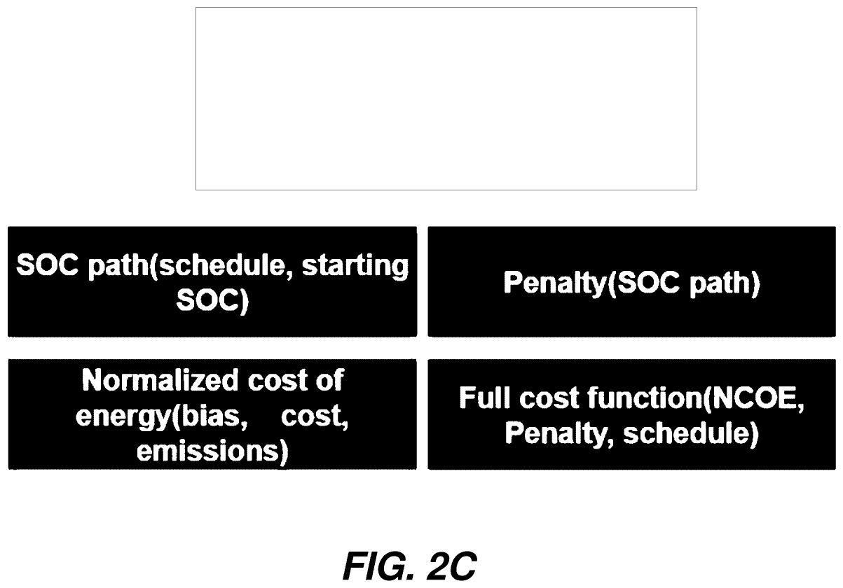

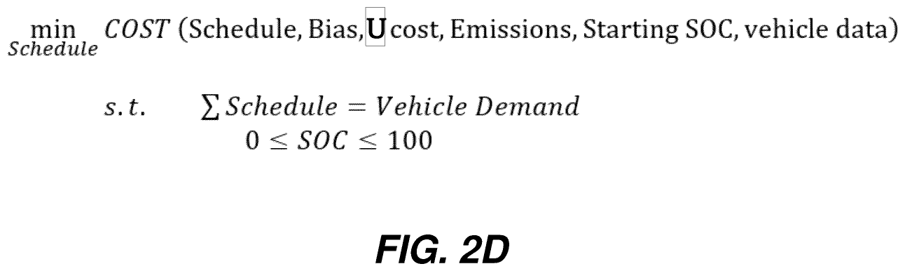

FIG. 2A illustrates an example simulation and optimization setup or process flow, which may be implemented with the system (102) or the schedule generator (114) therein. A simulation as described herein may start with raw data that describes grid emissions, household (energy) demand, home electricity (wiring or network) infrastructure, home based solar production, home based energy storage, vehicle driving or propulsion (energy) demand data, and so on.

Individual session datasets for corresponding individual (EV) charging sessions can be determined, extracted or isolated by the system (102) or the schedule generator (114) therein. For example, the schedule generator (114) may determine, establish, or receive user input specifying, a future time duration during which an EV will be available for charging or discharging operations at a home. This future time duration for the EV to be available at the home may be consecutive or continuous, may be referred to as an availability time window, and may represent an individual charging session for the EV.

The schedule generator (114) can perform simulation and optimization for each charging session during which the EV is at the home, whether or not a charge to the EV actually takes place. Individual session dataset—which may also be referred to as “single charge data (set)”—for the charging session or a corresponding future time duration can be isolated, determined or generated from the raw data and used by the schedule generator (114) to execute a simulation and optimization process flow that determines or generates an optimized charging (and/or discharging) schedule for the charging session.

Within the charging session, there may be numerous possible EV charging (and/or discharging) schedules, most—e.g., all but one, etc.—of which may not be optimal or the most optimized. All the possible EV charging (and/or discharging) schedules constitute a solution space for which the optimized charging (and/or discharging) schedule may be searched, estimated or predicted by the schedule generator (114) or the simulation and optimization process flow executed thereby.

In some operational scenarios, the simulation and optimization process flow can be repeatedly or iteratively executed to evaluate each of some or all of the possible EV charging (and/or discharging) schedules in the solution space. For example, performance metrics relating to emissions and/or energy production cost saved may be calculated for each of some or all of these possible schedules including the optimized schedule.

In some operational scenarios, a genetic algorithm (e.g., as an executable function or tool from MATLAB, an executable function or tool from another tool or algorithm library or provider, etc.) is invoked or executed by the schedule generator (114) to generate, determine, or search for the most optimized schedule in the solution space.

Additionally, optionally or alternatively, in some operational scenarios, AI/ML based models or techniques can be used to extract input features from the raw data or the isolated single charge data and estimate or predict the optimized schedule within the individual charging session. The AI/ML based models can be trained or developed beforehand—for example in a model training phase with training data that contains training raw data and ground truths—and used/applied to generate input features from (non-training) raw data and use the input features to infer or generate the optimized schedule in a model application phase relatively responsively as compared with the genetic algorithm approach. Additionally, optionally or alternatively, reinforcement learning without training data may be implemented or applied to generate optimized schedules for charging vehicles and for supporting home electricity consumptions at minimized emissions and utility costs.

As shown in FIG. 2A, the raw data or the individual session data set extracted therefrom may include (e.g., manufacturer-specific, manufacturer-proprietary, etc.) vehicle related inputs. Example vehicle (or EV) related inputs may include, but are not necessarily limited to only, any, some or all of: vehicle energy demand such as a specific number of miles of range to be added by the end of the charging session; a specific starting SOC of the vehicle, which may be used to ensure the vehicle's charge level at any given time in the charging session does not go above 100 or below 0; the vehicle's availability at the home, which may be specified or determined with specific start and end times for the charging session during which optimization can take place; and so on.

The raw data or the individual session data set extracted therefrom may include (e.g., manufacturer-specific, manufacturer-proprietary, etc.) battery related inputs. Example battery related inputs may include, but are not necessarily limited to only, a specific amount of (electric) energy or power used by the vehicle while it is idling.

All EVs may consume some energy or power while one or more functions—including charging and discharging or bidirectional actions—are operating with the EVs. This specific amount of energy or power during idling may be included in the simulation (or optimization) as any bidirectional action involving discharging energy or power from the vehicle to the home is to incur this specific amount of energy or power usage from the vehicle's battery in addition to what is supplied from the vehicle to the home.

In an optimized schedule that involves or specifies bidirectional actions that discharge electricity from the vehicle to the home, this inefficiency or usage of energy or power incurred even when the vehicle is otherwise idling while discharging electricity to the home may be compensated or surpassed or accounted for by a value added (or a corresponding cost reduction) in performing those bidirectional actions.

The raw data or the individual session data set extracted therefrom may include home related inputs. Example home related inputs may include, but are not necessarily limited to only, any, some or all of: a predicted home energy (or power) demand from the home during the charging session; a predicted (home) solar energy production during the charging session; a solar emissions factor; etc. While solar panels do not directly generate carbon emissions to produce energy once they have been manufactured, the manufacturing process does produce emissions. This emissions cost may be amortized over the lifetime of a solar panel, such as around 40 grams of CO2 per kilowatt hour (kWh) of energy produced.

The raw data or the individual session data set extracted therefrom may include grid related inputs. Example grid related inputs may include, but are not necessarily limited to only, (the next section of) time series values related to the grid and the energy produced by the grid. These time series values may include both emissions generated per unit energy consumed by a user of the grid produced energy and a (utility) cost to the user or customer (e.g., based on time-of-use rates, etc.) of each unit of energy.

Additionally, optionally or alternatively, the simulation and optimization as described herein may be performed or implemented further based on other inputs including but not limited to a bias factor. The bias factor may represent a specific value in a value range between zero (0) and one (1) and may be used to determine whether and how much optimization is based on emissions, (utility) cost, or a combination of the two. In some operational scenarios, the specific value for the bias factor may be selected or set by the user to determine how charging session(s) should be optimized or which cost factors should be given relatively high weights or contributions when evaluating the overall cost of a candidate schedule.

### 3.4 Schedule Values

A solution space or domain includes a plurality of possible or candidate schedules in which one of the possible/candidate schedules may be identified or selected as an optimized schedule. Each schedule in the plurality of possible/candidate schedules may include a time series or sequence of (per time slot) schedule values corresponding to different operational modes of energy exchange relating to an EV or a home at which the EV is connected to a home charger, as illustrated in FIG. 2B.

The schedule relates or specifies the per-slot schedule values to control actual or planned charging behaviors performed by a home charger (or electric vehicle supply equipment or EVSE) and the EV at each time step or time slot in a plurality of time steps or slots making up an EV availability time window in an EV charging and/or discharging session.

For each time slot in the availability time window, a respective schedule value may be set by the simulation and optimization process of the schedule generator (114 of FIG. 1B). The availability time window may include a sequence of (e.g., contiguous, consecutive, etc.) time slots. For each time slot, its schedule value represents whether and how much energy is flowing into or out of the EV's battery. The sign − plus (+) sign, minus (−) sign, or neither (0)—of this schedule value indicates a specific direction of energy and/or power transfer, relative to the EV battery, for the time slot. As illustrated in FIG. 2B, the different operational modes can be defined or specified based on the different (per-slot) schedule values.

More specifically, as illustrated on the left of FIG. 2B, if the schedule value (or schedule in short) for the time slot is greater than zero, then the EV's battery (denoted by a battery symbol) receives electricity energy as specified with the magnitude or absolute value of the schedule value. As specified with the plus (+) sign of the schedule value, the direction of energy and/or power transfer relative to the EV or EV battery is into the EV or EV's battery during the time slot. As shown in FIG. 2B, this energy and/or power transferred into the EV's battery may be made of (parts of) (1) home-based or home-supplied energy and/or power (as denoted by a combination of symbols for Sun and solar panel) generated by home-based solar energy generation, (2) energy and/or power supplied by the grid to which the home is connected, (3) a combination of the two, and so on. In addition, the home-based or home-supplied as well as grid-supplied energy and/or power is used to meet or satisfy energy and/or power demand or consumption (denoted by a house symbol) by (non-EV) appliances or electricity consuming devices attached to the home. It should be noted that (first EV) idle energy and/or power consumption incurred in this operational mode or state is accounted for in the optimized schedule or a possible/candidate schedule under techniques as described herein.

As illustrated at the center of FIG. 2B, if the schedule value (or schedule in short) for the time slot is zero, then the EV's battery does not receive (from the grid) or send (to the home electricity infrastructure) energy and/or power during the time slot. In this operational mode, the home-based or home-supplied as well as grid-supplied energy and/or power is used to meet or satisfy energy and/or power demand or consumption by the (non-EV) appliances or devices attached to the home. It should be noted that (second EV) idle energy and/or power consumption is still incurred in this operational mode or state and accounted for in the optimized schedule or a possible/candidate schedule under techniques as described herein.

As illustrated on the right of FIG. 2B, if the schedule value (or schedule in short) for the time slot is less than zero, then the EV's battery (denoted by a battery symbol) provides or sends energy and/or power—as specified with the magnitude or absolute value of the schedule value—to the home, for example by way of the home charger and home electricity infrastructure. As specified with the minus (−) sign of the schedule value, the direction of energy and/or power transfer relative to the EV or EV battery is from the EV or EV's battery during the time slot. The EV battery stored and/or home-based or home-supplied and/or grid-supplied energy and/or power is used to meet or satisfy energy and/or power demand or consumption (denoted by a house symbol) by (non-EV) appliances or electricity consuming devices attached to the home. It should be noted that (third EV) idle energy and/or power consumption incurred in this operational mode or state is accounted for in the optimized schedule or a possible/candidate schedule under techniques as described herein.

The first, second and third EV idle energy and/or power consumptions incurred in different operational modes or states may be different. The schedule generator (114) takes into account the idle energy and/or power consumptions as well as other data values (e.g., constants, variables, knowns, inputs, etc.) to balance energy and/or power transfers from or to the EV battery in the optimization problem. Some or all of the other data values or variables may be constants or knowns for a given time slot, but they may also vary from time slot to time slot.

Example data values used for setting up the optimization problem may include, but are not necessarily limited to only, (per time slot) solar production data, home demand, maximum vehicle charge rates, vehicle idle power consumption, and so on. Some or all of these other data values (or data value types) can be expressed as corresponding time series or time sequences. Each series/sequence element in a time series or time sequence representing a specific data value (or a specific data value type) may indicate or define a specific instance of the data value (type) for a respective time slot in a plurality of time slots that make up the (e.g., entire, etc.) availability time window of the charging and/or discharging session.

The optimization problem can be set up with some or all of these other or input data values. The optimized schedule for the availability time window or charging/discharging session is generated as a solution to the optimization problem. In a first example, a genetic algorithm is used to evaluate some or all possible or candidate schedules constituting a solution space or domain for the genetic algorithm. Each of the some or all possible/candidate schedules constitutes a genetic representation of the solution space/domain. As will be further explained in detail later in this disclosure, a full cost function built with cost and penalty functions may be used as a fitness or objective function to evaluate each of some of all the possible/candidate schedules in the solution space or domain. One of the possible/candidate schedules with the lowest full cost or with the most optimized fitness or objective value as determined by the full cost function may be selected or identified as the optimized schedule. In a second example, pretrained AI/ML models trained in a model training phase using training data sets can be applied in a model inference or application phase to generate or infer the optimized schedule.

A schedule such as the optimized schedule or a possible/candidate schedule specifies or includes a sequence of schedule values each of which identifies or specifies a direction of energy and/or power transfer relative to the EV battery and a magnitude of the energy and/or power transfer for a respective time slot in the plurality of time slots.

Additionally, optionally or alternatively, the schedule may also include a time series or sequence specifying or identifying (grid-supplied) electricity and/or power to be drawn from the grid. The (grid-supplied) electricity and/or power can be calculated based on the schedule with the schedule values indicating the direction and magnitude of the EV energy and/or power and other known quantities such as the other data values previously mentioned.

In some operational scenarios, home based energy storage (not shown in FIG. 2B) may be accounted for in the optimization problem or possible/candidate schedules as described herein. For example, home based energy storage may be used to store any un-used (home based) solar energy generated in earlier time slots or earlier sessions or at time intervals outside any EV availability time window. The energy stored in the home based energy storage may be tapped or used—as specified in the optimized schedule or a possible/candidate schedule to be evaluated for fitness with a fitness or full cost function—to power or supply electricity energy and/or power to be consumed by home appliances or devices at the home or to charge the EV battery at a later time in the EV availability time window.

By way of illustration but not limitation, a schedule value is determined for every time step or slot. The availability time window can be partitioned or divided into (non-overlapping, mutually exclusive) time slots at a specific temporal resolution or time scale. A time step or slot may represent the maximum granularity or finest time scale used to specify per-slot schedule values or other data values.

In some operational scenarios, different data values may use different temporal resolutions or time scales. For example, emission data for energy and/or power supplied by the grid may be provided at a first maximum granularity or finest time scale of every fifteen (15) minutes, whereas the schedule values may be attempted, generated or optimized at a second maximum granularity or finest time scale of every one (1) minute.

Each of some or all of these schedule values and other data values may be parametrized into a time series or time sequence of schedule or data values of a specific data value type using (e.g., identifiers, indexes, sequence numbers or integers of, etc.) time steps or slots as a parameter. The schedule contains or specifies the time series or sequence of schedule values for all the time steps or slots of the availability time window.

Depending on whether the schedule values are negative, positive, or zero values, the schedule can be used by the system (102) to define, specify, control or effectuate corresponding discharging, charging, or idling behaviors or operational modes of the EV in the time steps or slots.

In a first time step or slot with a negative schedule value, a total amount of solar energy and/or power generated at the home, a total amount of energy and/or power drawn from the grid, and a total amount of energy and/or power drawn from the EV battery add up to a total amount of energy and/or power consumed by the home (or non-EV appliances or devices therein) plus a total amount of energy and/or power used while the EV idles but incurred in discharging operations in the present example. Here, it is assumed that the EV battery supports bidirectional energy transfer. The total amount of energy and/or power discharged from the EV battery in the first time step or slot is equal to the magnitude of the negative schedule value set for the first time step or slot.

In a second time step or slot with a positive schedule value, a total amount of solar energy and/or power generated at the home and a total amount of energy and/or power drawn from the grid add up to the sum of a total amount of energy and/or power consumed by the home, a total amount of energy and/or power used while the EV idles but incurred in charging operations in the present example, and a total amount of energy and/or power charged to the vehicle's battery. The total amount of energy and/or power charged into the EV battery in the second time step or slot is equal to the magnitude of the positive schedule value set for the second time step or slot.

Hence, the energy and/or power being consumed by the EV while idling may be placed differently in discharging and charging calculations or summations. To realistically or correctly measure a net or total amount of energy and/or power flowing to or from the EV battery, the EV idle energy and/or power consumptions associated with discharging and charging as well as the correct placements in the summation operations of various quantities are considered and included in the simulation and optimization process as described herein.

In a third time step or slot with a zero schedule value, a total amount of solar energy and/or power generated at the home, a total amount of energy and/or power drawn from the grid add to a total amount of energy and/or power consumed by the home. In some operational scenarios, as the EV is not charging or discharging, (e.g., relatively negligible, etc.) idle energy and/or power consumption incurred may be ignored or may not be included in the energy and/or power balancing computations.

### 3.5. Schedule Evaluation

FIG. 2C illustrates example cost and penalty functions or measures that may be used in an overall or full cost function.—The overall or full cost function can be used in a genetic algorithm or AI/ML models to generate, identify, or search for an optimized schedule among possible or candidate schedules constituting a solution space or domain.

In operational scenarios in which a genetic algorithm is implemented or performed, the full cost function may represent, or may be used as, a fitness (or objective) function to evaluate each schedule in some or all possible/candidate schedules constituting a solution space or domain. Each possible or candidate schedule evaluated by the fitness function includes schedule values (or other data values, properties, variables, etc.) which can be (genetically) mutated and altered in the genetic algorithm to (e.g., iteratively, evolutionally, single or multiple schedule value changes at each mutation/alteration, etc.) generate some or all other possible/candidate schedules to be evaluated by the fitness function.

In operational scenarios in which AI/ML models are used in a model application or inference phase to generate predictions or inferences of optimized schedules for EV charging and/or discharging sessions, a full cost function may represent, or may be used as, an error/objective function to measure or generate prediction errors in a model training phase to train the AI/ML models.

More specifically, given a schedule, the functions as shown in FIG. 2C may be applied to evaluate or determine the schedule's fitness based at least in part on raw data or single charge data isolated therefrom as illustrated in FIG. 2A. A number of quantities can be computed as a part of the evaluation of the schedule, for example, in the genetic algorithm. Alternatively, optionally or alternatively, some or all of these quantities may be computed as input features to generate predictions of optimized schedules or in an error/objective function to determine or generate prediction errors of the predicted optimized schedules. These prediction errors may be used to optimize or train an AI/ML model in a model training phase.

As illustrated in FIG. 2C, the schedule generator (114) may perform a number of evaluation operations on a given schedule. First, the schedule generator (114) uses the schedule with schedule values for time slots (covering a charging and/or discharging session; contiguous, consecutive, or sequential) as input to determine a State of Charge (SOC) path as output. The SOC path determined from or for the schedule represents a plot or a curve of individual SOC values over these individual time slots, beginning at a specific SOC value (which may be the same for all the possible/candidate schedules in the solution space) of the EV battery. Each time slot may correspond to an individual SOC value of the SOC path. Each of the (individual) SOC values may be constrained or may range from 0 to 100 (percents). In the real world, SOC values of the EV battery cannot go outside of this value range of 0 to 100. However, in a simulation, some or all operations such as genetic mutations or alterations of schedules can cause a SOC value to be below or above this acceptable range. Hence, the schedule generator (114) or the genetic algorithm performed thereby may enforce the constraint and ensure each SOC value of a SOC path of a schedule such as the optimized schedule to comply with this constraint. In an example, any schedule generated through genetic mutation or alteration violating this constraint may be considered as a possible/candidate path or the optimized schedule in the solution space or domain but may be assessed with a penalty value. In another example, any schedule generated through genetic mutation or alteration violating this constraint may be excluded from being considered as a possible/candidate path or the optimized schedule in the solution space or domain.

Second, as illustrated in FIG. 2C, the schedule generator (114) may calculate a penalty based on the SOC path determined from the schedule and starting SOC value. To do so, a penalty function may be applied to the SOC path, depending on how the simulation and/or optimization problem is set up. In some operational scenarios, the penalty function may include only penalty terms for the SOC values (in corresponding time slots) exceeding the 0-100 value range. In some operational scenarios, the penalty function may include additional penalty terms added for high and low or upper or lower value sub-ranges (but still within the 0-100 value range) to account for battery aging.

Third, as illustrated in FIG. 2C, concurrently or sequentially, the schedule generator (114) may compute a normalized cost of (e.g., per unit, etc.) energy denoted as “NCOE”. This computation may include using a bias factor, a (time constant or time varying) utility cost per unit energy and a (time constant or time varying) emissions cost per unit energy as input to generate the NCOE as output. In some operational scenarios, the NCOE or simply “C” can be computed in an example cost function or expression, as follows:

C=Bias*(emissions generated per unit energy)+(1−Bias)*(cost per unit energy) (1)

The schedule generator (114) may apply a full cost function to compute a full cost of the given schedule based at least in part on the normalized cost of energy (NCOE) and the penalty and the schedule. In some operational scenarios, the full cost (denoted as “CF”) can be computed based on the previous two functions (for penalty and for normalized cost of energy), as follows:

CF(schedule)=C(schedule)+Penalty(schedule) (2)

Hence, the full cost for the schedule—which may be a possible/candidate schedule or the optimized schedule selected from the possible/candidate schedules in the solution space or domain within the EV availability time window of the EV charging and/or discharging session—may be computed to take into account utility cost, emission cost and penalties associated with or generated from the schedule. The full cost may be used in the simulation and optimization process to find the best possible charging schedule representing an ideal or the most optimized schedule with the lowest full cost among all the full costs of the possible/candidate schedules.

### 3.6 Example Operations

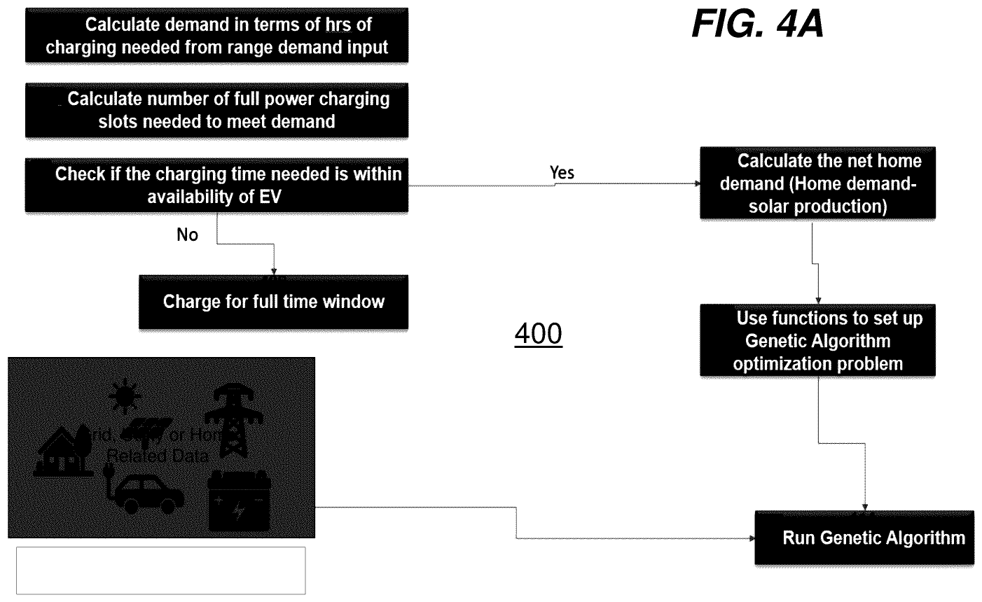

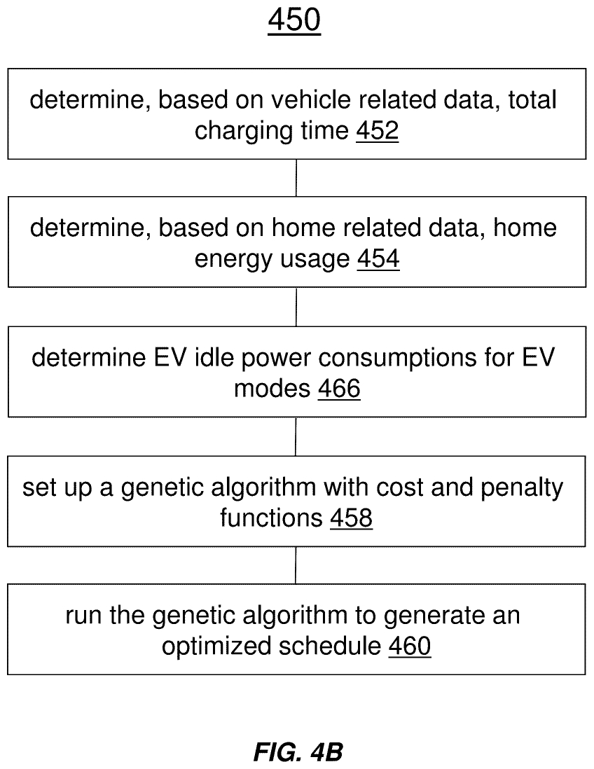

FIG. 4A illustrates an example process flow 400 for setting up an optimization problem to generate an optimized schedule for an EV charging and/or discharging session using an AI/ML based algorithm or a non-AI/ML (e.g., genetic algorithm or GA, etc.) algorithm. In some embodiments, one or more computing devices or components may perform this process flow.

Some or all grid related data, vehicle related data, home related data, a single charge data set isolated from raw data, etc., as discussed in connection with FIG. 2A may be used as inputs (or assumptions or knowns) to this process flow of FIG. 4A. Some or all of these inputs to the process flow may be represented as corresponding time series or time sequences.

In the process flow, how long charging at full power by the home charger to the EV is to meet or satisfy the EV energy (and/or power) demand may be calculated or determined from the inputs. The total number of time slots is to be used for charging at full power to meet or satisfy that EV demand can then be calculated or deduced. These time slots may be fixed time intervals corresponding to the finest time scale or resolution as specified in system and/or user configurable data of the system (102) or the schedule generator (114) therein. Example time slots may include fifteen (15) minute intervals, one (1) minute intervals, etc.

EV arrival and departure times may be used to delineate the EV availability time window in the EV charging and/or discharging session. Given these times, it is determined whether the available time or the total time duration of the EV availability time window or the total number of time slots therein is long enough to meet or satisfy the EV energy (or charging) demand.

In response to determining that the available time is insufficient or barely sufficient to achieve the desired or target state of charge (SOC) of the EV, the EV may be charged for the entire duration of the EV availability time window to meet the EV energy (and/or power) demand as best as possible, as further optimization may not be possible. On the other hand, in response to determining that the available time is more than what is needed to achieve the desired or target state of charge (SOC) of the EV, schedule optimization operations can proceed further. The net home energy (and/or power) demand may be calculated or determined. This is an adjusted home energy (and/or power) demand from the home energy (and/or power) demand from home appliances and devices attached with the home minus any predicted solar energy production (and/or home-based energy storage in some operational scenarios) for the duration of the EV charging and/or discharging session.

By way of illustration but not limitation, in block 402, a system (e.g., 102 of FIG. 1B, etc.) or a schedule generator (e.g., 114 of FIG. 1B, etc.) determines or receives information indicating an EV availability time window during which an EV is connected to a home charger (or home charging station) of a home. The schedule generator (114) can calculate, based at least in part on inputs such as a starting SOC value of the EV, an EV energy (and/or power) demand representing a total amount of energy (e.g., needed, etc.) to be charged into an EV in the EV availability time window of an EV charging and/or discharging session. This EV energy (and/or power) demand—e.g., in terms of kilowatt hour or kWh, etc.—may be used as an input to the optimization problem to be solved or used to generate or select an optimized schedule. The calculation of the EV energy (and/or power) demand may be vehicle specific. For example, a target driving range may be fed into or used as input in a vehicle-specific road load equation to calculate the EV energy (and/or power) demand. Additionally, optionally or alternately, the EV energy (and/or power) demand can be deduced or calculated through linear interpolation using a vehicle-specific rated range of the EV and/or the target driving range.

In block 404, the schedule generator (114) calculates a total EV charging time needed for the home charger to charge the EV battery based at least in part on the EV energy (and/or power) demand and a charger specification applicable or specific to the home charger. The total EV charging time may be represented by a total number of hours of EV charging or a total number of (mutually exclusive, non-overlapping) time slots of EV charging.

In block 406, the schedule generator (114) checks or determines whether the total EV charging time or the total number of hours or time slots fits within the EV availability time window in the EV charging and/or discharging session. Start and end times of the availability time window may be predicted or determined in part or in whole based on user input generated from interactions with a (e.g., human, etc.) user via one or more user interfaces implemented with the system (102) or the schedule generator (114).

In block 408, in response to determining (in block 406) that the total charging time is no less than the EV availability time window, the schedule generator (114) proceeds to instruct or cause the home charger to charge the EV for the entire EV availability time window.

In response to determining (in block 406) that the total charging time is less than the EV availability time window, the process flow goes to block 410.

In block 410, the schedule generator (114) calculates a net or total home energy (and/or power) demand of the home during the EV availability time window or over a future time period (e.g., the next 24 hours, etc.) encompassing the EV availability time window. The net or total home energy (and/or power) demand may be calculated as an average home demand per unit time over all time slots used to partition or divide the EV availability time window or the future time period, or as time varying home demand in a time series or sequence over all the time slots of the EV availability time window. The schedule generator (114) may include or factor in home based solar energy production in calculating the net or total home demand during the EV availability time window or the future time period, as follows:

Net=Home demand−Solar production (3)

where “Net” on the left-hand side or LHS denotes the net or total home energy (and/or power) demand after the solar energy production is included or factored in; “Home demand” on the right-hand side or RHS denotes the pre-adjusted home energy (and/or power) demand (without or before taking into account the solar production).

Additionally, optionally or alternatively, in some operational scenarios, the schedule generator (114) may include or factor in home based energy storage during the EV availability time window or the future time period.

In block 412, the schedule generator (114) uses cost and penalty functions or a full cost function generated therein to set up the optimization problem to be solved for the purpose of finding, selecting, predicting or otherwise generating an optimized schedule for the EV charging and/or discharging session in this scenario or session.

FIG. 2D illustrates an example optimization problem to be solved by one or more AI based or non-AI/ML based algorithms implemented or performed by the schedule generator (114). A solution to this optimization problem may be obtained by (1) varying schedules in a solution space or domain, (2) evaluating full costs of all the schedules, (3) determining a minimized (or the least) full cost among all the full costs, selecting a specific schedule—from among all the schedules—with the least full cost as the solution to the optimization problem, etc. As a result, the specific schedule with the least full cost may be used or generated as the optimized schedule as described herein.

As illustrated in FIG. 2D, the full cost (denoted as “COST”) of each to-be-evaluated schedule may be computed in part or in whole based or depending on individual schedule values (denoted as “Schedule”) as specified with the to-be-evaluated schedule for all time slots in the EV availability time window of the EV charging and/or discharging session, (per-energy-unit) utility cost of the time slots denoted as “U cost”, (per-energy-unit) emission cost denoted as “Emissions”, starting SOC of the EV to be charged in the scenario or session, vehicle (related) data used to determine a target EV range or a corresponding target SOC or a corresponding EV energy (and/or power) demand to be achieved or satisfied at the end of the EV charging and/or discharging session, etc. Each of some or all of these inputs, parameters or data values for computing the full cost (“COST”) may be represented in a time series or sequence of data elements of a respective input, data value or parameter type.

The optimization problem may be solved with a specific condition or constraint that the sum of all the schedule values in a to-be-evaluated schedule in the optimization problem equals the total energy (and/or power) demand requested by or determined for the EV for that EV charging and/or discharging session. Additionally, optionally or alternatively, in some operational scenarios, the optimization problem may be solved with a second (further) specific condition or constraint that the SOC of the EV at any given time point or time slot in the EV charging and/or discharging session does not exceed or lie outside the value range of 0 to 100 (percents).

Under techniques as described herein, this optimization problem may, but is not necessarily limited to only, be solved by an AI/ML based algorithm or by a (non-AI/ML) generic algorithm, as defined or specified in part or in whole with the grid, EV and home related data inputs.

In block 414, the schedule generator (114) runs the AI/ML based algorithm or genetic algorithm with an error, objective, fitness or full cost function built with the cost and penalty functions to generate the optimized schedule as a solution to the optimization problem.

AI/ML and/or non-AI/ML algorithms may be used to generate an optimized algorithm. By way of example but not limitation, a genetic algorithm is used to generate the optimized schedule, cost (e.g., utility cost, emission cost, full cost, with bias factor, etc.) and penalty functions as described herein may be used to set up the optimization problem to be solved by the genetic algorithm. The genetic algorithm may be provided as an executable function or code packet from an algorithm/tool provider such as MATLAB or another source.

The genetic algorithm (or GA) is free to vary individual schedule values of a to-be-evaluated schedule (or a genetic representation) for the EV availability time window to generate other to-be-evaluated schedules (or other genetic representations) in the solution space or domain.

A range of acceptable (schedule) values for each of some or all schedule values in a schedule may be set up, enforced or specified, for example as constraint(s)/condition(s)/input(s), for the genetic algorithm when the genetic algorithm is invoked or executed. The lower limit or minimum value threshold for this range of acceptable values for the schedule values may be the negative sum of the (e.g., net, etc.) home energy and/or power demand plus the EV idle energy and/or power. This lower limit may represent a maximum energy and/or power at which the EV can discharge. The upper limit or minimum value threshold for this range of acceptable values for the schedule values may be the (positive, maximum) energy and/or power rating supported by the home charger used to charge the EV at the home. An example value of the rating of the home charger may, but is not necessarily limited to only, 7 kW.

### 3.7. Example Visualization

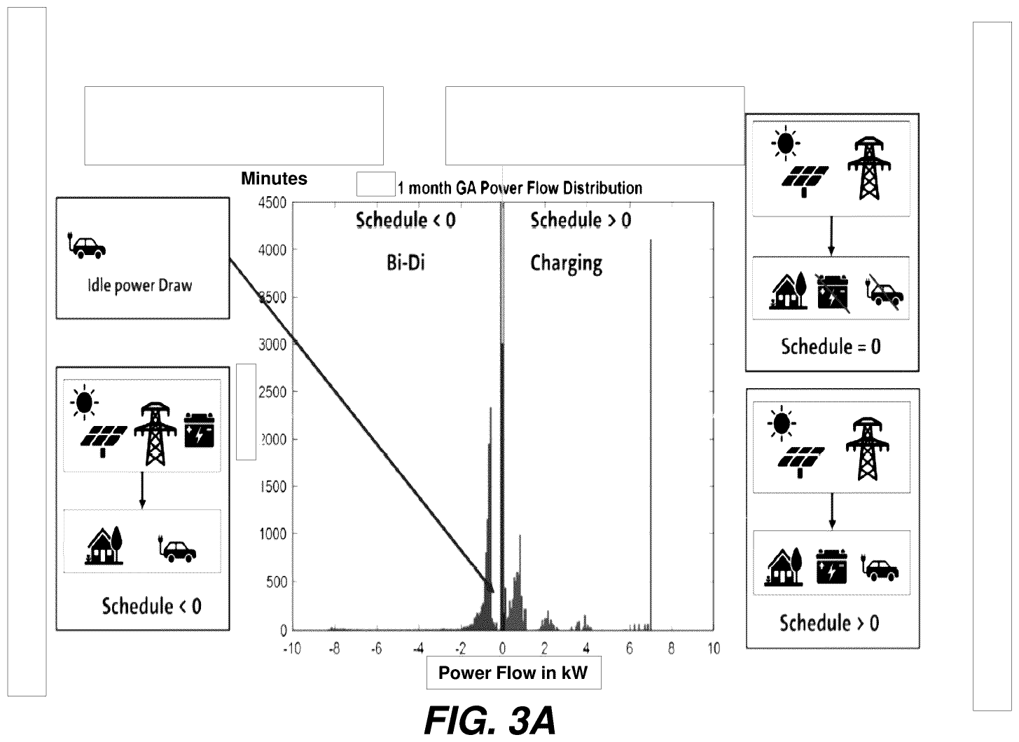

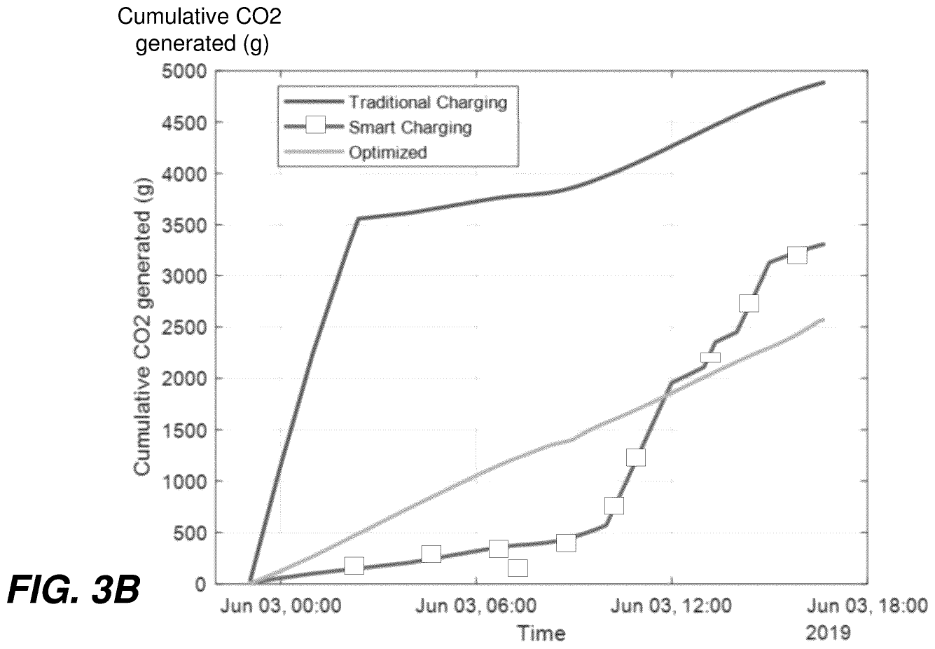

FIG. 3A illustrates an example visualization or display page of a distribution of time slots with specified different schedule values. These different schedule values are specified in the time slots in optimized schedules generated using techniques as described herein for EV availability time windows or EV charging and/or discharging sessions over a relatively long time period such as a one-month time period.

The horizontal or X axis (or coordinate) in FIG. 3A represents the range of acceptable (schedule) values—e.g., in terms of power flows in kW—for the different schedule values. As noted, the sign and magnitude of a schedule value determined for a time slot in a given optimized schedule of the optimized schedules specifies or controls specific the direction and amount of electricity energy/power transfers into or out of an EV battery in that time slot of the given optimized schedule for an EV availability time window or an EV charging and/or discharging session.

The vertical or Y axis (or coordinate) in FIG. 3A represents a specific (total/count of) time intervals specified with a specific schedule value in the X axis. The specific total/count of the time intervals for the specific schedule value may be aggregated or summed, for example, in terms or units of minutes. Different totals/counts of time intervals for different schedule values may be stored or computed with a histogram having a plurality of histogram bins. Each histogram bin in the plurality of histogram bins may be used to derive or calculate a respective total/count of time intervals for a respective schedule value in a plurality of schedule values constituting the range of acceptable (schedule) values represented in the X axis/coordinate of FIG. 3A.

The distribution of time intervals or slots represented in the plot of FIG. 3A may be derived or calculated from (counting total numbers and total time durations of) time slots respectively specified with the different schedule values of the optimized schedules generated for EV availability time windows or EV charging and/or discharging sessions in the one-month time period.

In these EV availability time windows, the EV may operate in the time slots in the distribution as shown in FIG. 3A with a number of different EV operational modes or states such as (1) connected and charging; (2) connected and not charging; and (3) connected and discharging. In the same EV time availability time windows, a home in which a home charger is connected with the EV in the EV availability time windows may operate in the time slots in the distribution as shown in FIG. 3A with a number of different home operational modes or states such as (1) using power from the (utility/electricity) grid to which the home electricity infrastructure is connected; (2) using power from the EV; (3) using electricity energy/power generated from home solar panels (and/or home based energy storage); and (4) using electricity energy/power from a combination from some or all of the foregoing.

As illustrated in FIG. 3A, where a schedule value is negative (the X region to the left of the Y axis/coordinates), it represents that the EV is giving away or discharging from its battery electricity/power to the home. In this EV operational mode, it may be observed that varying energy/power levels (or varying magnitudes of negative schedule values) are used in the optimized schedules (e.g., generated with the genetic algorithm or GA, etc.) to operate the EV and home. Different totals/counts of time intervals (minutes) may be observed in FIG. 3A for these varying schedule value levels.

The plot of FIG. 3A exhibits a first peak in the negative schedule value region. This first peak is at a certain horizontal distance (e.g., corresponding to an electricity power of 400 watts, etc.) away from a second peak coinciding the Y axis. The second peak represents the total/count of time intervals corresponding to the zero (0) schedule value or the EV operational mode in which the EV is connected but neither charges nor discharges. This gap between the first peak and the second peak corresponds to—or is factored in or implemented by optimization techniques as described herein to relatively realistically account for—idle energy/power consumption by the EV. These peaks and the gap in FIG. 3A shows that these techniques does—or tends to—not start EV electricity energy/power sharing from the EV to the home until an energy/power demand from the home is sufficiently large such as more than 400 watts (which may correspond to the EV idle energy/power consumption).

In addition, it is observed that the optimization techniques or optimized schedules generated thereby also operate the EV in no EV energy/power transfer or exchange mode (connected but not charging, or schedule=0). This is because utility and emission costs of energy or power may lower either from home based solar panels or directly from the grid in this EV operational mode. For example, in this EV operational mode or state, home loads (or home energy/power consumption levels) are small enough for the home based solar panels to support directly or for a combination of home based solar energy/power and that of the grid. Utility and emission costs associated with the home based solar energy/power and/or that of the grid are relatively low as compared with costs (e.g., including but not limited to carbon intensity amortized for EV battery manufacturing, etc.) associated with EV energy/power of the EV battery.

As illustrated in FIG. 3A, where a schedule value is positive (the X region to the right of the Y axis/coordinates), it represents the EV battery being charged for driving demand or for (e.g., time-shifted, later, subsequent, etc.) bidirectional energy transfer operations. It is observed that the optimization techniques such as the genetic algorithm or GA charges the EV at different power levels (corresponding to different positive schedule values), peaking out at a maximum positive schedule value such as 7 kW which represents the maximum rating supported by or capacity of the home charger used to charge the EV.

As can be observed in the plot of FIG. 3A, the optimization techniques or the optimized schedules generated thereby charges the EV at varying rates (corresponding to varying positive schedule values) and spends varying amounts of times at those varying rates. In addition, sometimes, a behavior is observed that, to meet the EV charging demand, the EV battery are controlled to consume full electricity power for whole time slots. These behaviors and characteristics of the optimization techniques and/or the corresponding optimized schedules prove that these techniques are effective and trustworthy, and that these techniques can be implemented or applied in a wide variety of real world scenarios to solve complicated problems of energy management with no or little user input.

FIG. 3B illustrates an example visualization or display page of cumulative emissions generated under different EV charging techniques. These cumulative emissions are generated by an EV and a home in which the EV is electrically connected to a home charger for a single EV availability time window or EV charging (and/or discharging) session corresponding to an eighteen (18) hour time period from June 2 to June 3. As shown, by the end of the session, there are significant differences among different cumulative emissions generated by existing non-optimized charging techniques (referred to as “traditional charging”), other optimized charging techniques (referred to as “smart charging”) and optimized charging techniques as described herein (referred to as “optimized”) the genetic algorithm optimized bidirectional schedule. As the optimized charging techniques take into account home based solar energy (and/or home based energy storage) and home load data in addition to grid emissions during the EV availability time window, an optimized schedule generated by these techniques results in relatively significantly lower emissions generated over the full length of the EV charging and/or discharging session.

### 4.0. EXAMPLE PROCESS FLOWS

FIG. 4B illustrates an example process flow 400 according to an embodiment. In some embodiments, one or more computing devices or components may perform this process flow. In block 452, a system as described herein determines, based at least in part on vehicle related data, total charging time to be used to charge an electric vehicle (EV) from a starting state of charge (SOC) to a target SOC.

In block 454, the system determines, based at least in part on home related data, home energy usage of a home in an EV availability time window during which the EV is electrically connected with electricity infrastructure of the home via a home charger.

In block 456, the system determines EV idle power consumptions for an EV charging mode, an EV discharging mode, and an EV idle mode with neither charging nor discharging.

In block 458, the system sets up a genetic algorithm with cost and penalty functions. The cost and penalty functions are built, for each candidate schedule in a plurality of candidate schedules in a solution space to be evaluated by the genetic algorithm, based at least in part on the starting state of charge, the home energy usage and the EV idle power consumptions.

In block 460, the system runs the genetic algorithm to generate an optimized schedule among the plurality of candidate schedules in the solution space. The optimized schedule includes a plurality of schedule values for the plurality of time slots in the EV availability time window to control whether the EV is to charge, discharge or idle in each time slot in the plurality of time slots.

In an embodiment, the genetic algorithm is set up to generate the optimized schedule in response to determining that the EV availability time window is longer than the total charging time.

In an embodiment, the cost and penalty functions include a penalty function relating to one or more ranges of SOC values for one or more batteries of the EV.

In an embodiment, the cost and penalty functions include a cost function that combines utility costs and emission costs based on a bias factor.

In an embodiment, the home energy usage is represented as a time series for the plurality of time slots in the EV availability time window.

In an embodiment, a specific sign and a specific magnitude of each schedule value in the plurality of schedule values in the optimized schedule controls a specific direction and a specific amount of electricity energy flow between the EV and the electricity infrastructure of the home for a respective time slot in the plurality of time slots.

In an embodiment, each schedule value in the plurality of schedule values in the optimized schedule is determined for a respective time slot based at least in part on home energy usage during the respective time slot, home based solar energy generation during the respective time slot, and EV idle power consumption during the respective time slot.

In an embodiment, the schedule value is determined for the respective time slot based further on home energy storage allocated to the respective time slot.

In an embodiment, a computing device is configured to perform any of the foregoing methods. In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

In an embodiment, a computing device comprising one or more processors and one or more storage media storing a set of instructions which, when executed by the one or more processors, cause performance of any of the foregoing methods.

Other examples of these and other embodiments are found throughout this disclosure. Note that, although separate embodiments are discussed herein, any combination of embodiments and/or partial embodiments discussed herein may be combined to form further embodiments.

### 5.0. IMPLEMENTATION MECHANISM—HARDWARE OVERVIEW

According to one embodiment, the techniques described herein are implemented by one or more special-purpose computing devices. The special-purpose computing devices may be desktop computer systems, portable computer systems, handheld devices, smartphones, media devices, gaming consoles, networking devices, or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques.

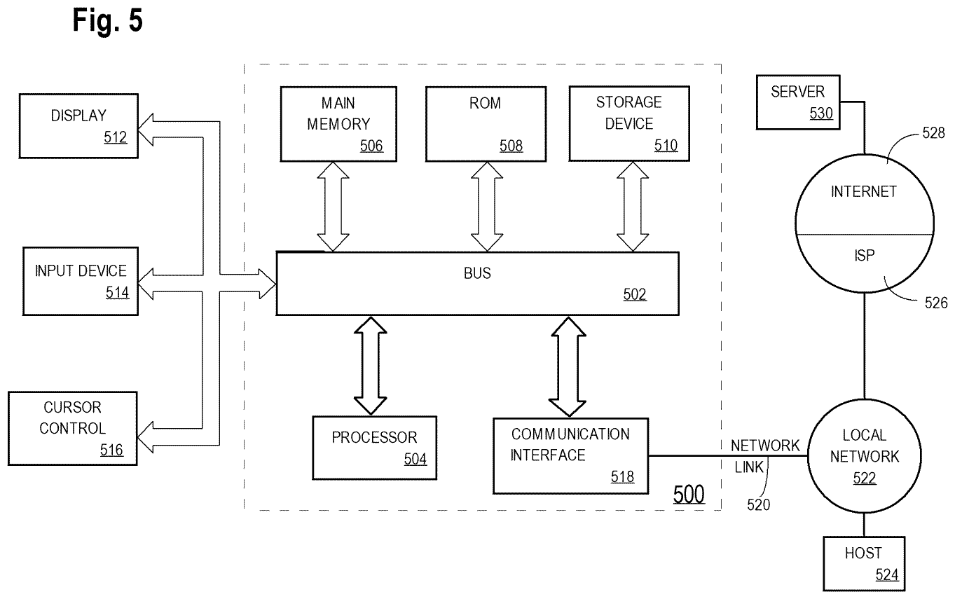

FIG. 5 is a block diagram that illustrates a computer system 500 utilized in implementing the above-described techniques, according to an embodiment. Computer system 500 may be, for example, a desktop computing device, laptop computing device, tablet, smartphone, server appliance, computing main image, multimedia device, handheld device, networking apparatus, or any other suitable device.

Computer system 500 includes one or more busses 502 or other communication mechanism for communicating information, and one or more hardware processors 504 coupled with busses 502 for processing information. Hardware processors 504 may be, for example, a general purpose microprocessor. Busses 502 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 500 also includes a main memory 506, such as a random access memory (RAM) or other dynamic or volatile storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes one or more read only memories (ROM) 508 or other static storage devices coupled to bus 502 for storing static information and instructions for processor 504. One or more storage devices 510, such as a solid-state drive (SSD), magnetic disk, optical disk, or other suitable non-volatile storage device, is provided and coupled to bus 502 for storing information and instructions.

Computer system 500 may be coupled via bus 502 to one or more displays 512 for presenting information to a computer user. For instance, computer system 500 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 512 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 512.

In an embodiment, output to display 512 may be accelerated by one or more graphics processing unit (GPUs) in computer system 500. A GPU may be, for example, a highly parallelized, multi-core floating point processing unit highly optimized to perform computing operations related to the display of graphics data, 3D data, and/or multimedia. In addition to computing image and/or video data directly for output to display 512, a GPU may also be used to render imagery or other video data off-screen, and read that data back into a program for off-screen image processing with very high performance. Various other computing tasks may be off-loaded from the processor 504 to the GPU.

One or more input devices 514 are coupled to bus 502 for communicating information and command selections to processor 504. One example of an input device 514 is a keyboard, including alphanumeric and other keys. Another type of user input device 514 is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane. Yet other examples of suitable input devices 514 include a touch-screen panel affixed to a display 512, cameras, microphones, accelerometers, motion detectors, and/or other sensors. In an embodiment, a network-based input device 514 may be utilized. In such an embodiment, user input and/or other information or commands may be relayed via routers and/or switches on a Local Area Network (LAN) or other suitable shared network, or via a peer-to-peer network, from the input device 514 to a network link 520 on the computer system 500.

A computer system 500 may implement techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and use a modem to send the instructions over a network, such as a cable network or cellular network, as modulated signals. A modem local to computer system 500 can receive the data on the network and demodulate the signal to decode the transmitted instructions. Appropriate circuitry can then place the data on bus 502. Bus 502 carries the data to main memory 505, from which processor 504 retrieves and executes the instructions. The instructions received by main memory 506 may optionally be stored on storage device 510 either before or after execution by processor 504.

A computer system 500 may also include, in an embodiment, one or more communication interfaces 518 coupled to bus 502. A communication interface 518 provides a data communication coupling, typically two-way, to a network link 520 that is connected to a local network 522. For example, a communication interface 518 may be an integrated services digital network (ISDN) card, cable modem, satellite modem, or a modem to provide a data communication connection to a corresponding type of telephone line. As another example, the one or more communication interfaces 518 may include a local area network (LAN) card to provide a data communication connection to a compatible LAN. As yet another example, the one or more communication interfaces 518 may include a wireless network interface controller, such as a 802.11-based controller, Bluetooth controller, Long Term Evolution (LTE) modem, and/or other types of wireless interfaces. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by a Service Provider 526. Service Provider 526, which may for example be an Internet Service Provider (ISP), in turn provides data communication services through a wide area network, such as the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

In an embodiment, computer system 500 can send messages and receive data, including program code and/or other types of instructions, through the network(s), network link 520, and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution. As another example, information received via a network link 520 may be interpreted and/or processed by a software component of the computer system 500, such as a web browser, application, or server, which in turn issues instructions based thereon to a processor 504, possibly via an operating system and/or other intermediate layers of software components.

In an embodiment, some or all of the systems described herein may be or comprise server computer systems, including one or more computer systems 500 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. EXTENSIONS AND ALTERNATIVES

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the drawings, the various components are depicted as being communicatively coupled to various other components by arrows. These arrows illustrate only certain examples of information flows between the components. Neither the direction of the arrows nor the lack of arrow lines between certain components should be interpreted as indicating the existence or absence of communication between the certain components themselves. Indeed, each component may feature a suitable communication interface by which the component may become communicatively coupled to other components as needed to accomplish any of the functions described herein.

In the foregoing specification, embodiments of the disclosure have been described with reference to numerous specific details that may vary from implementation to implementation. Thus, the sole and exclusive indicator of what is the disclosure, and is intended by the applicants to be the disclosure, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method comprising:
determining, based at least in part on vehicle related data, total charging time to be used to charge an electric vehicle (EV) from a starting state of charge (SOC) to a target SOC;
determining, based at least in part on home related data, home energy usage of a home in an EV availability time window during which the EV is electrically connected with electricity infrastructure of the home via a home charger;
determining EV idle power consumptions for an EV charging mode, an EV discharging mode, and an EV idle mode with neither charging nor discharging;
setting up a genetic algorithm with cost and penalty functions, wherein the cost and penalty functions are built, for each candidate schedule in a plurality of candidate schedules in a solution space to be evaluated by the genetic algorithm, based at least in part on the starting state of charge, the home energy usage and the EV idle power consumptions;
running the genetic algorithm to generate an optimized schedule among the plurality of candidate schedules in the solution space, wherein the optimized schedule includes a plurality of schedule values for the plurality of time slots in the EV availability time window to control whether the EV is to charge, discharge or idle in each time slot in the plurality of time slots.

2. The method of claim 1, wherein the genetic algorithm is set up to generate the optimized schedule in response to determining that the EV availability time window is longer than the total charging time.

3. The method of claim 1, wherein the cost and penalty functions include a penalty function relating to one or more ranges of SOC values for one or more batteries of the EV.

4. The method of claim 1, wherein the cost and penalty functions include a cost function that combines utility costs and emission costs based on a bias factor.

5. The method of claim 1, wherein the home energy usage is represented as a time series for the plurality of time slots in the EV availability time window.

6. The method of claim 1, wherein a specific sign and a specific magnitude of each schedule value in the plurality of schedule values in the optimized schedule controls a specific direction and a specific amount of electricity energy flow between the EV and the electricity infrastructure of the home for a respective time slot in the plurality of time slots.

7. The method of claim 1, wherein each schedule value in the plurality of schedule values in the optimized schedule is determined for a respective time slot based at least in part on home energy usage during the respective time slot, home based solar energy generation during the respective time slot, and EV idle power consumption during the respective time slot.

8. The method of claim 1, wherein the schedule value is determined for the respective time slot based further on home energy storage allocated to the respective time slot.

9. One or more non-transitory computer readable media storing a program of instructions that is executable by one or more computing processors to perform:
determining, based at least in part on vehicle related data, total charging time to be used to charge an electric vehicle (EV) from a starting state of charge (SOC) to a target SOC;
determining, based at least in part on home related data, home energy usage of a home in an EV availability time window during which the EV is electrically connected with electricity infrastructure of the home via a home charger;
determining EV idle power consumptions for an EV charging mode, an EV discharging mode, and an EV idle mode with neither charging nor discharging;
setting up a genetic algorithm with cost and penalty functions, wherein the cost and penalty functions are built, for each candidate schedule in a plurality of candidate schedules in a solution space to be evaluated by the genetic algorithm, based at least in part on the starting state of charge, the home energy usage and the EV idle power consumptions;
running the genetic algorithm to generate an optimized schedule among the plurality of candidate schedules in the solution space, wherein the optimized schedule includes a plurality of schedule values for the plurality of time slots in the EV availability time window to control whether the EV is to charge, discharge or idle in each time slot in the plurality of time slots.

10. The media of claim 9, wherein the genetic algorithm is set up to generate the optimized schedule in response to determining that the EV availability time window is longer than the total charging time.

11. The media of claim 9, wherein the cost and penalty functions include a penalty function relating to one or more ranges of SOC values for one or more batteries of the EV.

12. The media of claim 9, wherein the cost and penalty functions include a cost function that combines utility costs and emission costs based on a bias factor.

13. The media of claim 9, wherein the home energy usage is represented as a time series for the plurality of time slots in the EV availability time window.

14. The media of claim 9, wherein a specific sign and a specific magnitude of each schedule value in the plurality of schedule values in the optimized schedule controls a specific direction and a specific amount of electricity energy flow between the EV and the electricity infrastructure of the home for a respective time slot in the plurality of time slots.

15. The media of claim 9, wherein each schedule value in the plurality of schedule values in the optimized schedule is determined for a respective time slot based at least in part on home energy usage during the respective time slot, home based solar energy generation during the respective time slot, and EV idle power consumption during the respective time slot.

16. The media of claim 9, wherein the schedule value is determined for the respective time slot based further on home energy storage allocated to the respective time slot.

17. A system, comprising: one or more computing processors; one or more non-transitory computer readable media storing a program of instructions that is executable by the one or more computing processors to perform:
determining, based at least in part on vehicle related data, total charging time to be used to charge an electric vehicle (EV) from a starting state of charge (SOC) to a target SOC;
determining, based at least in part on home related data, home energy usage of a home in an EV availability time window during which the EV is electrically connected with electricity infrastructure of the home via a home charger;
determining EV idle power consumptions for an EV charging mode, an EV discharging mode, and an EV idle mode with neither charging nor discharging;
setting up a genetic algorithm with cost and penalty functions, wherein the cost and penalty functions are built, for each candidate schedule in a plurality of candidate schedules in a solution space to be evaluated by the genetic algorithm, based at least in part on the starting state of charge, the home energy usage and the EV idle power consumptions;
running the genetic algorithm to generate an optimized schedule among the plurality of candidate schedules in the solution space, wherein the optimized schedule includes a plurality of schedule values for the plurality of time slots in the EV availability time window to control whether the EV is to charge, discharge or idle in each time slot in the plurality of time slots.

18. The system of claim 17, wherein the genetic algorithm is set up to generate the optimized schedule in response to determining that the EV availability time window is longer than the total charging time.

19. The system of claim 17, wherein the cost and penalty functions include a penalty function relating to one or more ranges of SOC values for one or more batteries of the EV.

20. The system of claim 17, wherein the cost and penalty functions include a cost function that combines utility costs and emission costs based on a bias factor.

21. The system of claim 17, wherein the home energy usage is represented as a time series for the plurality of time slots in the EV availability time window.

22. The system of claim 17, wherein a specific sign and a specific magnitude of each schedule value in the plurality of schedule values in the optimized schedule controls a specific direction and a specific amount of electricity energy flow between the EV and the electricity infrastructure of the home for a respective time slot in the plurality of time slots.

23. The system of claim 17, wherein each schedule value in the plurality of schedule values in the optimized schedule is determined for a respective time slot based at least in part on home energy usage during the respective time slot, home based solar energy generation during the respective time slot, and EV idle power consumption during the respective time slot.

24. The system of claim 17, wherein the schedule value is determined for the respective time slot based further on home energy storage allocated to the respective time slot.
